(19) United States
(12) Patent Application Publication
(10) Pub. No.: US 2026/0180729 A1
(43) Pub. Date: Jun. 25, 2026

(54) TECHNIQUES FOR TONE MAPPING FOR 60 MHZ DISTRIBUTION BANDWIDTH

(71) Applicant: QUALCOMM Incorporated, San Diego, CA (US)

(72) Inventors: Lin YANG, San Diego, CA (US); Bin TIAN, San Diego, CA (US); Youhan KIM, Saratoga, CA (US); Tzu-Hsuan CHOU, San Diego, CA (US)

(21) Appl. No.: 19/064,368

(22) Filed: Feb. 26, 2025

Related U.S. Application Data
(63) Continuation-in-part of application No. 18/999,725, filed on Dec. 23, 2024.

(51) Int. Cl. H04L 5/00; H04L 1/00

(52) U.S. Cl. CPC H04L 5/0023; H04L 1/0011

(57) ABSTRACT

This disclosure provides methods, components, devices and systems for techniques for tone mapping for 60 MHz distribution bandwidth. Some aspects more specifically relate to techniques for tone mapping for the 60 MHz distribution bandwidth that support distributed transmissions. In some examples, the wireless device may obtain data for transmission in a physical layer convergence protocol (PLCP) protocol data unit (PPDU) over an 80 megahertz (MHz) distribution bandwidth. The 80 MHz distribution bandwidth may be punctured providing a 60 MHz distribution bandwidth. Cyclic shift delays (CSDs) are respectively applied to a plurality of distribution resource units (dRUs) of the PPDU in accordance with a first CSD index pattern defined for a first 60 MHz or a second 60 MHz of a 80 MHz distribution bandwidth or a second CSD index pattern defined for a first 40 MHz and a second 40 MHz of the 80 MHz distribution bandwidth.

### CROSS REFERENCE

The present Application for Patent is a continuation-in-part of U.S. patent application Ser. No. 18/999,725 by YANG et al., entitled “TECHNIQUES FOR TONE MAPPING FOR 60 MHZ DISTRIBUTION BANDWIDTH,” filed Dec. 23, 2024, assigned to the assignee hereof, and is expressly incorporated by reference in its entirety herein.

### TECHNICAL FIELD

This disclosure relates generally to wireless communication and, more specifically, to techniques for tone mapping for a 60 MHz distribution bandwidth.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless device. The method may include obtaining data for transmission in a physical layer convergence protocol (PLCP) protocol data unit (PPDU) and transmitting the PPDU over an 80 megahertz (MHz) distribution bandwidth, where the 80 MHz distribution bandwidth is punctured providing a 60 MHz distribution bandwidth, where a first 20 MHz distributed resource unit (dRU) tone plan, a second 20 MHz dRU tone plan, and a third 20 MHz dRU tone plan are interleaved over the 60 MHz distribution bandwidth.

Another innovative aspect of the subject matter described in this disclosure can be implemented in a wireless device for wireless communications. The wireless device may include a processing system that includes processor circuitry and memory circuitry that stores code. The processing system may be configured to cause the wireless device to obtain data for transmission in a PLCP PPDU and transmit the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth.

Another innovative aspect of the subject matter described in this disclosure can be implemented at a wireless device for wireless communications. The wireless device may include means for obtaining data for transmission in a PLCP PPDU and means for transmitting the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth.

Another innovative aspect of the subject matter described in this disclosure can be implemented at a non-transitory computer-readable medium storing code for wireless communications. The code may include instructions executable by one or more processors to obtain data for transmission in a PLCP PPDU and transmit the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth.

In some examples of the method, wireless devices, and non-transitory computer-readable medium described herein, a first tone of the second 20 MHZ dRU tone plan may be offset relative to a first tone of the first 20 MHz dRU by two tones.

In some examples of the method, wireless devices, and non-transitory computer-readable medium described herein, a first tone of the third 20 MHZ dRU tone plan may be offset relative to a first tone of the first 20 MHz dRU by one tone.

In some examples of the method, wireless devices, and non-transitory computer-readable medium described herein, a set of twenty-six tone dRU may be associated with each of the first 20 MHz dRU tone plan, the second 20 MHZ dRU tone plan, and the third 20 MHz dRU tone plan and the transmission of the PPDU abstains from using the set of twenty-six tone dRU.

In some examples of the method, wireless devices, and non-transitory computer-readable medium described herein, a first set of pilot tones for a first twenty-six tone dRU may be associated with the first 20 MHz dRU tone plan, a second set of pilot tones for a second twenty-six tone dRU may be associated with the second 20 MHZ dRU tone plan, and a third set of pilot tones for a third twenty-six tone dRU may be associated with the third 20 MHz dRU tone plan and the second set of pilot tones may be offset relative to the first set of pilot tones and the third set of pilot tones may be offset relative to the first set of pilot tones.

In some examples of the method, wireless devices, and non-transitory computer-readable medium described herein, a sequence of values representing a short training field (STF) of the PPDU may be based on a STF sequence associated with triggered transmission and an 80 MHz bandwidth, and the values may be populated only over a non-punctured portion of the 80 MHz bandwidth that corresponds to a multiple resource unit four hundred eighty-four plus two hundred forty-two.

Another innovative aspect of the subject matter described in this disclosure can be implemented in a method for wireless communications at a wireless device. The method may include obtaining data for transmission in a PLCP PPDU and transmitting the PPDU over an 80 MHz distribution bandwidth, where the 80 MHz distribution bandwidth is punctured providing a 60 MHz distribution bandwidth, where one or more cyclic shift delays (CSDs) are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth.

Another innovative aspect of the subject matter described in this disclosure can be implemented at a wireless device for wireless communications. The wireless device may include a processing system that includes processor circuitry and memory circuitry that stores code. The processing system may be configured to cause the wireless device to obtain data for transmission in a PLCP PPDU and transmit the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth.

Another innovative aspect of the subject matter described in this disclosure can be implemented at a wireless device for wireless communications. The wireless device may include means for obtaining data for transmission in a PLCP PPDU and means for transmitting the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth.

Another innovative aspect of the subject matter described in this disclosure can be implemented at a non-transitory computer-readable medium storing code for wireless communications. The code may include instructions executable by one or more processors to obtain data for transmission in a PLCP PPDU and transmit the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth.

Another innovative aspect of the subject matter described in this disclosure can be implemented in a method for wireless communications at a wireless device. The method may include receiving a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth and obtaining data from the PPDU.

Another innovative aspect of the subject matter described in this disclosure can be implemented at a wireless device for wireless communications. The wireless device may include a processing system that includes processor circuitry and memory circuitry that stores code. The processing system may be configured to cause the wireless device to receive a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth and obtain data from the PPDU.

Another innovative aspect of the subject matter described in this disclosure can be implemented at a wireless device for wireless communications. The wireless device may include means for receiving a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth and means for obtaining data from the PPDU.

Another innovative aspect of the subject matter described in this disclosure can be implemented at a non-transitory computer-readable medium storing code for wireless communications. The code may include instructions executable by one or more processors to receive a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth and obtain data from the PPDU.

Another innovative aspect of the subject matter described in this disclosure can be implemented in a method for wireless communications at a wireless device. The method may include receiving a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth and obtaining data from the PPDU.

Another innovative aspect of the subject matter described in this disclosure can be implemented at a wireless device for wireless communications. The wireless device may include a processing system that includes processor circuitry and memory circuitry that stores code. The processing system may be configured to cause the wireless device to receive a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth and obtain data from the PPDU.

Another innovative aspect of the subject matter described in this disclosure can be implemented at a wireless device for wireless communications. The wireless device may include means for receiving a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth and means for obtaining data from the PPDU.

Another innovative aspect of the subject matter described in this disclosure can be implemented at a non-transitory computer-readable medium storing code for wireless communications. The code may include instructions executable by one or more processors to receive a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth and obtain data from the PPDU.

Another innovative aspect of the subject matter described in this disclosure can be implemented in a method for wireless communications by a wireless device. The method may include obtaining data for transmission in a PPDU and transmitting the PPDU over an 80 MHz distribution bandwidth, where the 80 MHz distribution bandwidth is punctured providing a 60 MHz distribution bandwidth, where one or more CSDs are respectively applied to a set of multiple distribution resource units dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth.

Another innovative aspect of the subject matter described in this disclosure can be implemented in a wireless device for wireless communications. The wireless device may include a processing system that includes processor circuitry and memory circuitry that stores code. The processing system may be configured to cause the wireless device to obtain data for transmission in a PPDU and transmit the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth.

Another innovative aspect of the subject matter described in this disclosure can be implemented at a wireless device for wireless communications is described. The wireless device may include means for obtaining data for transmission in a PPDU and means for transmitting the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth.

Another innovative aspect of the subject matter described in this disclosure can be implemented at a non-transitory computer-readable medium storing code for wireless communications. The code may include instructions executable by one or more processors to obtain data for transmission in a physical layer convergence protocol (PLCP) protocol data unit (PPDU) and transmit the PPDU over an 80 megahertz (MHz) distribution bandwidth, where the 80 MHz distribution bandwidth is punctured providing a 60 MHz distribution bandwidth, where one or more cyclic shift delays (CSDs) are respectively applied to a set of multiple distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth.

In some examples of the method, wireless devices, and non-transitory computer-readable medium described herein, the first CSD index pattern includes a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

In some examples of the method, wireless devices, and non-transitory computer-readable medium described herein, the second CSD index pattern includes a first set of CSD indices associated with a dRU52, a dRU106, and a dRU242 of the first 40 MHz and a second set of CSD indices associated with a dRU106, a dRU242, and a dRU484 of the second 40 MHz.

In some examples of the method, wireless devices, and non-transitory computer-readable medium described herein, a set CSD indices associated with the dRU106 of a first 40 MHz of the second CSD index pattern may be complementary to a set of CSD indices associated with the dRU52 of a third 20 MHz of the second CSD index pattern.

In some examples of the method, wireless devices, and non-transitory computer-readable medium described herein, the second CSD index pattern includes a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

In some examples of the method, wireless devices, and non-transitory computer-readable medium described herein, the set of multiple global CSD assignment index values associated with the 60 MHz distribution bandwidth includes global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

Another innovative aspect of the subject matter described in this disclosure can be implemented in a method for wireless communications by a wireless device. The method may include receiving a PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth and obtaining data from the PPDU.

Another innovative aspect of the subject matter described in this disclosure can be implemented in a wireless device for wireless communications. The wireless device may include a processing system that includes processor circuitry and memory circuitry that stores code. The processing system may be configured to cause the wireless device to receive a PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth and obtain data from the PPDU.

Another innovative aspect of the subject matter described in this disclosure can be implemented at a wireless device for wireless communications. The wireless device may include means for receiving a PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth and means for obtaining data from the PPDU.

Another innovative aspect of the subject matter described in this disclosure can be implemented at a non-transitory computer-readable medium storing code for wireless communications. The code may include instructions executable by one or more processors to receive a PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth and obtain data from the PPDU.

In some examples of the method, wireless devices, and non-transitory computer-readable medium described herein, the first CSD index pattern includes a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

In some examples of the method, wireless devices, and non-transitory computer-readable medium described herein, the second CSD index pattern includes a first set of CSD indices associated with a dRU52, a dRU106, and a dRU242 of the first 40 MHz and a second set of CSD indices associated with a dRU106, a dRU242, and a dRU484 of the second 40 MHz.

In some examples of the method, wireless devices, and non-transitory computer-readable medium described herein, a set CSD indices associated with the dRU106 of a first 40 MHz of the second CSD index pattern may be complementary to a set of CSD indices associated with the dRU52 of a third 20 MHz of the second CSD index pattern.

In some examples of the method, wireless devices, and non-transitory computer-readable medium described herein, the second CSD index pattern includes a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

In some examples of the method, wireless devices, and non-transitory computer-readable medium described herein, the set of multiple global CSD assignment index values associated with the 60 MHz distribution bandwidth includes global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a frequency diagram depicting an example distributed tone mapping for the 60 MHz distribution bandwidth.

FIG. 7 shows an example of a pilot tone design that supports techniques for tone mapping for 60 MHz distribution bandwidth.

FIG. 8 shows an example of a frequency diagram depicting an example pilot tone mapping for the 60 MHz distribution bandwidth.

FIG. 9 shows an example of a pilot tone design that supports techniques for tone mapping for 60 MHz distribution bandwidth.

FIG. 10 shows an example of a pilot tone design that supports techniques for tone mapping for 60 MHz distribution bandwidth.

FIG. 11 shows an example of a pilot tone design that supports techniques for tone mapping for 60 MHz distribution bandwidth.

FIG. 12 shows an example of a pilot tone design that supports techniques for tone mapping for 60 MHz distribution bandwidth.

FIG. 13 shows an example of a global CSD index assignment diagram that supports techniques for tone mapping for 60 MHz distribution bandwidth.

FIG. 14 shows examples of global CSD index assignment diagrams that support techniques for tone mapping for 60 MHz distribution bandwidth.

FIG. 15 shows examples of global CSD index assignment diagrams that support techniques for tone mapping for 60 MHz distribution bandwidth.

FIG. 16 shows examples of global CSD index assignment diagrams that support techniques for tone mapping for 60 MHz distribution bandwidth.

FIG. 17 shows examples of global CSD index assignment diagrams that support techniques for tone mapping for 60 MHz distribution bandwidth.

FIG. 18 shows an example of a global CSD index assignment diagram that supports techniques for tone mapping for 60 MHz distribution bandwidth.

FIG. 19 shows examples of global CSD index assignment diagrams that support techniques for tone mapping for 60 MHz distribution bandwidth.

FIG. 20 shows an example of a process flow that supports techniques for tone mapping for 60 MHz distribution bandwidth.

FIG. 21 shows a block diagram of an example wireless communication device that supports techniques for tone mapping for 60 MHz distribution bandwidth.

FIG. 22 shows a block diagram of an example wireless communication device that supports techniques for tone mapping for 60 MHz distribution bandwidth.

FIG. 23 shows a block diagram of an example wireless communication device that supports techniques for tone mapping for 60 MHz distribution bandwidth.

FIGS. 24 through 29 show flowcharts illustrating example processes performable by or at a wireless device that supports techniques for tone mapping for 60 MHz distribution bandwidth.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless devices may support communications in various frequency bands, such as 2.4 GHz band and 5 GHz band, as well as extended frequency bands (such as the 6 GHz band). Each of the frequency bands may include multiple sub-bands or frequency channels for signaling physical layer convergence procedure (PLCP) protocol data units (PPDUs). The PPDUs may be transmitted by the wireless devices over a wireless channel including a minimum bandwidth of 20 megahertz (MHz), or bandwidths of 40 MHz, 80 MHz, 160 MHz, or 320 MHz. In some examples, the wireless devices may support distributed transmission or the transmission of the PLCP PPDU on noncontiguous tones or subcarriers of the wireless channel, such as in accordance with a distributed tone plan. The noncontiguous tones represent a distributed resource unit (dRU). In some implementations, one 20 MHz subchannel may be punctured in the 80 MHz distribution bandwidth, and a maximal distribution bandwidth may be 60 MHz. The wireless device may be unable to process or use the 60 MHz distribution bandwidth. For example, the wireless device may not have a mechanism for a dRU tone mapping over the 60 MHz distribution bandwidth. The wireless device may not have a mechanism for a short training field (STF) sequence for trigger-based (TB) PPDU on the 60 MHz distribution bandwidth. The wireless device may not have a mechanism for a dRU index-based global cyclic shift delay (CSD) assignment for 60 MHz distribution bandwidth transmission.

Various aspects relate generally to distributed transmissions. Some aspects more specifically relate to techniques for tone mapping for the 60 MHz distribution bandwidth that support distributed transmissions. In some examples, a dRU tone mapping over 60 MHz distribution bandwidth may be constructed using a 20 MHz dRU tone mapping spread onto 60 MHz and dRUs from different 20 MHz are mapped to 60 MHz tones in an interleaved way. For example, the wireless device may obtain data for transmission in a PLCP PPDU. The wireless device may transmit the PPDU over an 80 MHz distribution bandwidth. The 80 MHz distribution bandwidth may be punctured providing a 60 MHz distribution bandwidth. A first 20 MHz dRU tone plan, a second 20 MHz dRU tone plan, and a third 20 MHz dRU tone plan may be interleaved over the 60 MHz distribution bandwidth. In some examples, a first tone of the second 20 MHz dRU tone plan may be offset relative to a first tone of the first 20 MHz dRU by two tones; a first tone of the third 20 MHz dRU tone plan may be offset relative to the first tone of the first 20 MHz dRU by one tone. In some implementations, a sequence of values representing a STF of the PPDU may be based on a STF sequence associated with triggered transmission and an 80 MHz bandwidth, and the values may be populated over a non-punctured portion of the 80 MHz bandwidth that corresponds to a multiple resource unit four hundred eighty-four plus two hundred forty-two. In some examples, one or more CSDs may be respectively applied to a plurality of dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a plurality of global CSD assignment index values associated with the 60 MHz distribution bandwidth. In some examples, one or more CSDs may be respectively applied to a plurality of dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth.

Particular aspects of the subject matter described in this disclosure can be implemented to realize one or more of the following potential advantages. In some examples, the dRU tone mapping over the 60 MHz distribution bandwidth may be used to provide distributed transmissions. Distributed transmission provides greater flexibility in medium utilization for wireless channels. In some implementations, a distributed tone plan may map pilot tone locations to localized regions of the wireless channel. Pilot tones are used for phase alignment and parameter tracking. However, when pilot tones are squeezed into localized regions of the wireless channel, interference in such localized regions can effectively eliminate the pilot tones in the dRU. By mapping the relative locations of pilot tones, aspects of the present disclosure may ensure that the pilot tones associated with the dRU are evenly distributed across the wireless channel or otherwise distributed in a manner that is more robust against interference on the wireless channel.

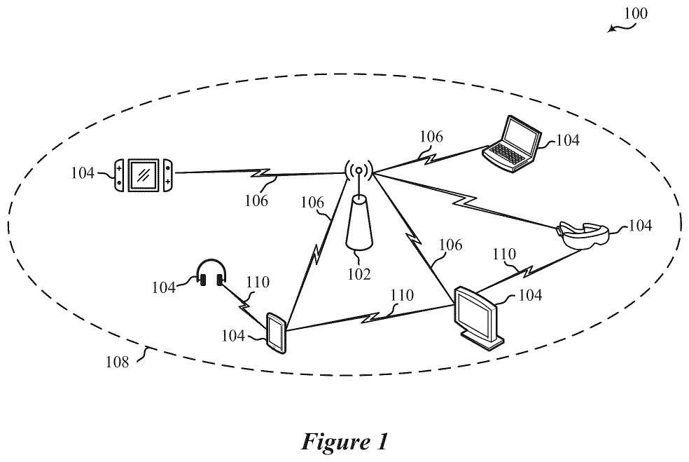

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

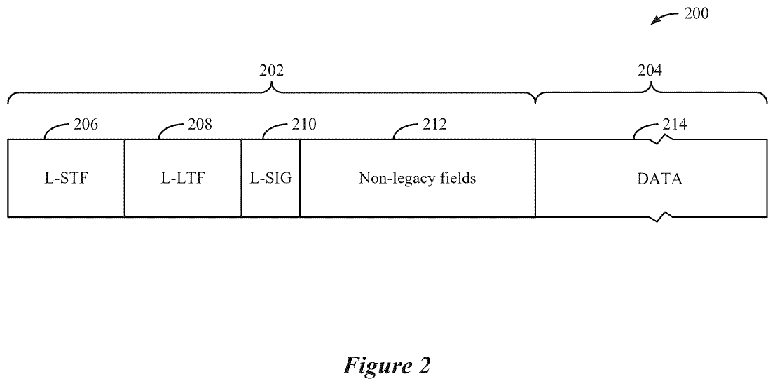

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

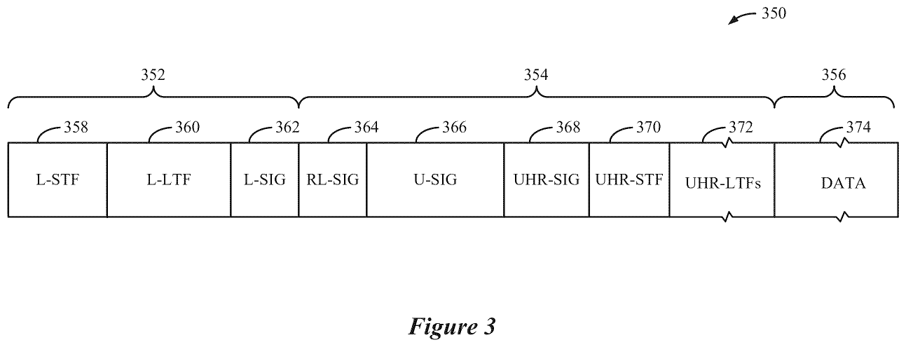

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

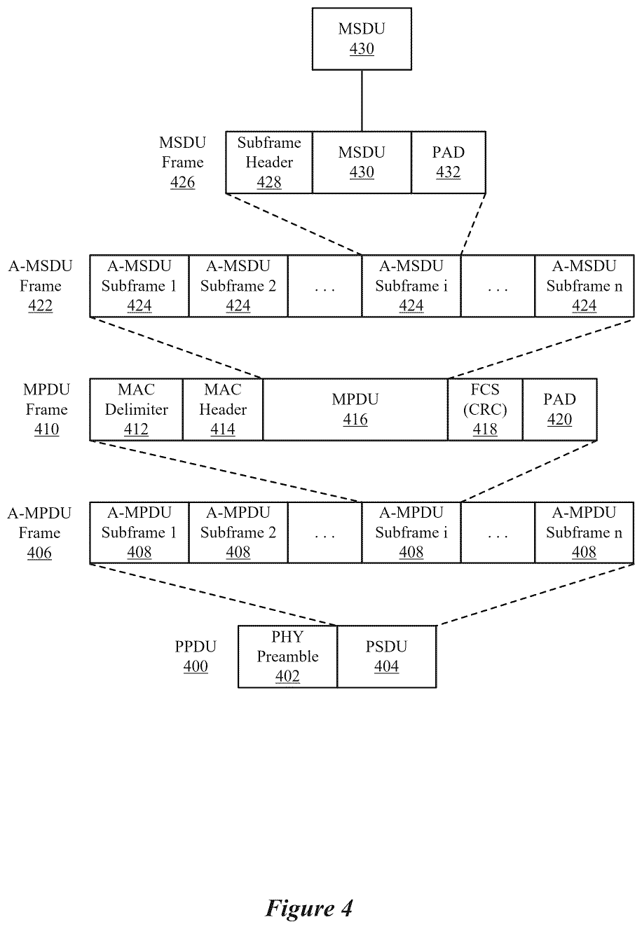

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

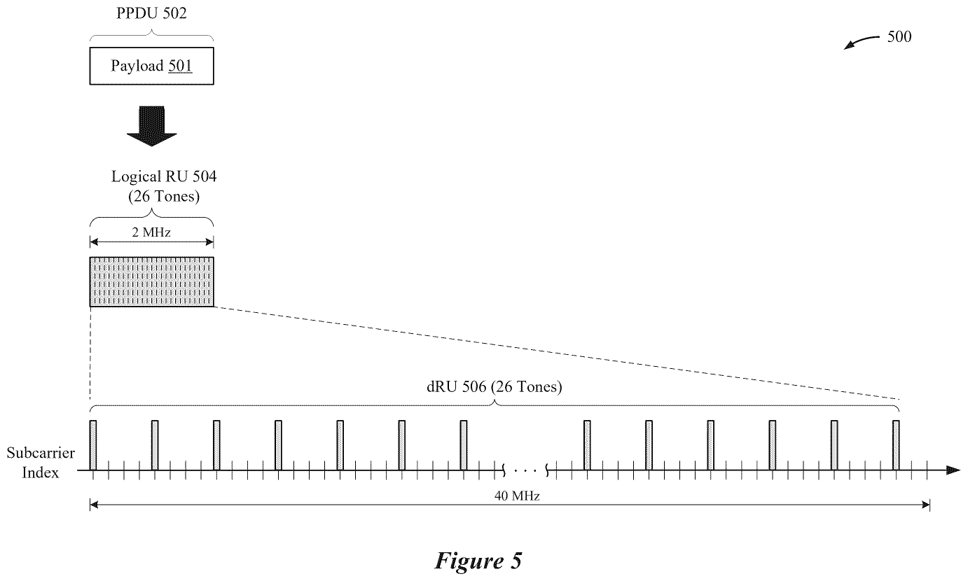

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent an rRU of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

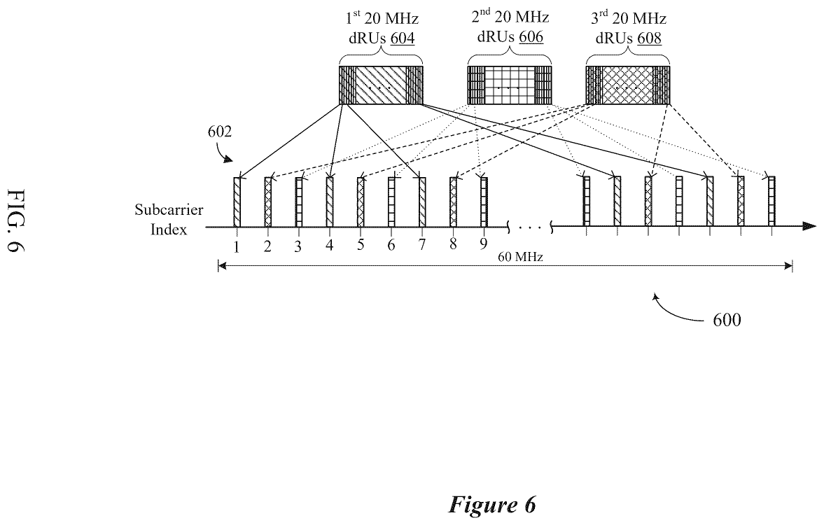

FIG. 6 shows an example of a frequency diagram 600 depicting an example distributed tone mapping for the 60 MHz distribution bandwidth. The frequency diagram 600 depicting the distributed tone mapping for the 60 MHz distribution bandwidth may implement aspects of wireless communication network 100, aspects of PDU 200, aspects of the PPDUs 300 and 400, or aspects of frequency diagram 500. Aspects of the frequency diagram 600 may be implemented at or implemented by one or more wireless devices, which may be an example of the corresponding device(s) described herein. The wireless device may be an example of a UE, a STA, an AP, or a network entity.

In some implementations, one 20 MHz subchannel may be punctured in an 80 MHz distribution bandwidth (such as 80 MHz PPDU or 80 MHz subblock of a wider bandwidth PPDU), and a maximal distribution bandwidth may be the 60 MHz distribution bandwidth. The 60 MHz bandwidth may be contiguous or not contiguous. For example, the punctured 20 MHz subchannel may be represented by an x and the not punctured 20 MHz subchannel may be represented by a 1, and the contiguous 60 MHz distribution bandwidth may be represented as 111x or x111, and the not contiguous 60 MHz distribution bandwidth may be represented as 1x11 or 11x1.

For 80 MHz distribution bandwidth with the punctured 20 MHz subchannel, the dRU tone mapping over the 60 MHz distribution bandwidth may be constructed by using a 20 MHz dRU tone mapping spread onto the 60 MHz and the dRUs from different 20 MHz may be mapped to 60 MHz tones in an interleaved way. For example, a first 20 MHz dRU tone plan, a second 20 MHz dRU tone plan, and a third 20 MHz dRU tone plan may interleaved over the 60 MHz distribution bandwidth.

Table 1 illustrates a data and pilot subcarrier indices (i) of dRUs in a 20 MHz distribution bandwidth. The data and pilot subcarrier indices are used to map to 60 MHz tones and interleaved with dRUs from different 20 MHz distribution bandwidths.

TABLE 1

| dRU type | dRU index and subcarrier range | | | | |
|---|---|---|---|---|---|
| 26-tone | dRU1 | dRU2 | dRU3 | dRU4 | dRU5 |
| dRU | [−120:9:−12, | [−116:9:−8, | [−118:9:−10, | [−114:9:−6, | [−112:9:−4, |
| i = 1:9 | 6:9:114] | 10:9:118] | 8:9:116] | 12:9:120] | 5:9:113] |
| | dRU6 | dRU7 | dRU8 | dRU9 | |
| | [−119:9:−11, | [−115:9:−7, | [−117:9:−9, | [−113:9:−5, | |
| | 7:9:115] | 11:9:119] | 9:9:117] | 4:9:112] | |

| 52-tone | dRU1 | dRU2 |
|---|---|---|
| dRU | 26-tone [dRU1, dRU2] | 26-tone [dRU3, dRU4] |
| i = 1:4 | dRU3 | dRU4 |
| | 26-tone [dRU6, dRU7] | 26-tone [dRU8, dRU9] |
| 106-tone | dRU1 | dRU2 |
| dRU | 26-tone [dRU1~4], [−3, 3] | 26-tone [dRU6~9], [−2, 2] |
| i = 1:2 | | |

FIG. 6 shows an example mapping 602 of the 20 MHz dRU tone plans distributed for transmission over the 60 MHz distribution bandwidth of the wireless channel. The 20 MHz dRU may correspond to frequency tones of two hundred forty-two tone RU and an under-covered dRU twenty-six tones, fifty-two tones, or one hundred six tones. In the illustrated example, the mapping 602 may spread tones of the first 20 MHz dRU 604 to the 60 MHz bandwidth. The mapping 602 may spread tones of the second 20 MHz dRU 606 to the 60 MHz bandwidth. The tones of the second 20 MHz dRU 606 may be interleaved with the tones from the first 20 MHz dRU 604. In some implementations, tones from the second 20 MHz dRU 606 may be placed by shifting the tones from the first 20 MHz dRU 604 by two tones to the right (such as a first tone of the second 20 MHz dRU tone plan is offset relative to a first tone of the first 20 MHz dRU by two tones). The mapping 602 may spread tones of the third 20 MHz dRU 608 to the 60 MHz bandwidth. The tones of the third 20 MHz dRU 608 may be interleaved with the tones from the first 20 MHz dRU 604 and the second 20 MHz dRU 606. In some implementations, tones from the third 20 MHz dRU 608 may be placed by shifting the tones from the first 20 MHz dRU 604 by one tone to the right (such as a first tone of the third 20 MHz dRU tone plan is offset relative to the first tone of the first 20 MHz dRU by one tone).

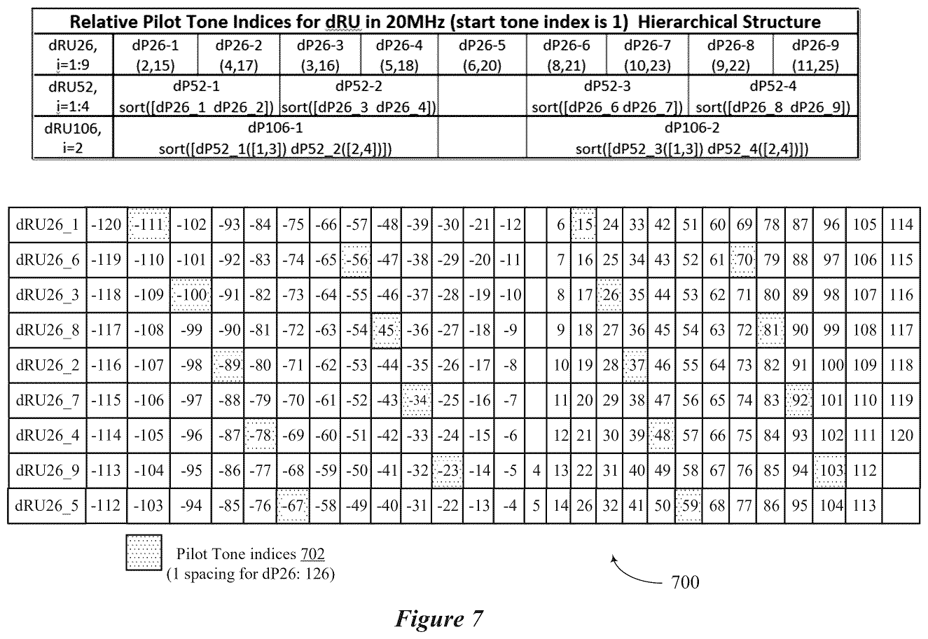

FIG. 7 shows an example of a pilot tone design 700 that supports techniques for tone mapping for 60 MHz distribution bandwidth. The pilot tone design 700 may implement aspects of wireless communication network 100, aspects of PDU 200, aspects of the PPDUs 300 and 400, or aspects of frequency diagrams 500 and 600. Aspects of the pilot tone design 700 may be implemented at or implemented by one or more wireless devices, which may be an example of the corresponding device(s) described herein. The wireless device may be an example of a UE, a STA, an AP, or a network entity.

The pilot tone design 700 illustrates the relative pilot tone indices 702 for dRU in 20 MHz where a start tone index is 1. The pilot tone design 700 provides a hierarchical uniform pilot structure of distance of 11 for the 20 MHz distribution bandwidth, 40 MHz distribution bandwidth, or 80 MHz distribution bandwidth. The pilot tone design 700 provides enough separation of pilots for any combination of dRUs. The fixed pilot separation patterns for large dRUs ease channel smoothing and achieve better smoothing gain.

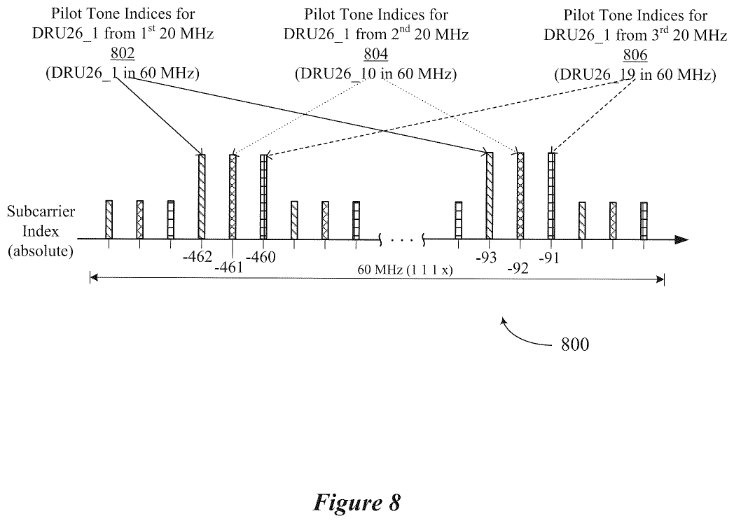

FIG. 8 shows an example of a frequency diagram 800 depicting an example distributed pilot tones mapping for the 60 MHz distribution bandwidth. The frequency diagram 800 may implement aspects of wireless communication network 100, aspects of PDU 200, aspects of the PPDUs 300 and 400, aspects of frequency diagram 500, or aspects of the pilot tone design 700. Aspects of the frequency diagram 800 may be implemented at or implemented by one or more wireless devices, which may be an example of the corresponding device(s) described herein. The wireless device may be an example of a UE, a STA, an AP, or a network entity.

Due to the 60 MHz dRU tone mapping being based on spreading of the tones of the 20 MHz dRU plans and interleaving the tones from different 20 MHz dRU tone plans (such as the first 20 MHz dRU tone plan, the second 20 MHz tone plan, and the third 20 MHz dRU tone plan), if the existing pilot tones in 20 MHz dRU tone plans still serve as pilot tones in 60 MHz distributed bandwidth tone mapping, the pilot tones for the same dRU (such as same size and same index) from different 20 MHz dRU tone plans will be next to each other in the 60 MHz spectrum line resulting in the pilot tones stacking together in the 60 MHz tone mapping. The frequency diagram 800 illustrates the pilot tone stacking. The pilot tone indices for dRU26_1 from the first 20 MHz 802, the pilot tone indices for dRU26_1 from the second 20 MHz 804, and the pilot tone indices for dRU26_1 from the third 20 MHz 806 stack in two local areas (such as at frequencies associated with indices −462, −461, −460, −93, −92, and −91). In case of interference or spurs in any of the two local areas, the dRU26_1 receiving wireless device (such as AP) from different 20 MHz suffers. When pilot tones are squeezed into localized regions of the wireless channel, interference in such localized regions can effectively eliminate the pilot tones in the dRU. For example, a receiving device may fail to receive pilot tones in any of the dRU26 if it experiences a deep fade in any of these localized regions.

In some implementations, to address the pilot tone stacking from the spreading and interleaving of the first 20 MHz dRU tone plan, the second 20 MHz tone plan, and the third 20 MHz dRU tone plan, the relative pilot tone locations in each 20 MHz tone plan may be mapped and interleaved to the 60 MHz distribution bandwidth, but the twenty-six tone dRU (dRU26) may not be supported in the 60 MHz distribution bandwidth. For example, no dRU26 may be assigned to users. The dRU26 may not be supported in the 60 MHz distribution bandwidth, and the smallest dRU in the 60 MHz distribution bandwidth may be the fifty-two tone dRU (dRU52). Another reason for not supporting the dRU26 is that the dRU26 may saturate from a maximum power in the 40 MHz distributed bandwidth.

In some implementations, to address the pilot tone stacking from the spreading and interleaving of the first 20 MHz dRU tone plan, the second 20 MHz tone plan, and the third 20 MHz dRU tone plan, the relative pilot tone locations in the 20 MHz tone plans may be slightly adjusted for the dRU26 and larger dRUs and mapped to the 60 MHz distribution bandwidth. For example, a first set of pilot tones for a dRU26 of the first 20 MHz dRU tone plan, a second set of pilot tones for a dRU26 of the second 20 MHz dRU tone plan, and a third set of pilot tones for a dRU26 of the third 20 MHz dRU tone plan may be offset relative to each other. In some implementations, the second set of pilot tones is offset relative to the first set of pilot tones, and the third set of pilot tones is offset relative to the first set of pilot tones. The relative offset may ensure that the pilot tones associated with the dRU26 are evenly distributed across the wireless channel or otherwise distributed in a manner that is more robust against interference on the wireless channel. For example, evenly distributing the pilot tones over the wireless channel increases the likelihood that a receiving device will receive at least some of the pilot tones even if it experiences a deep fade in one or more localized regions of the wireless channel.

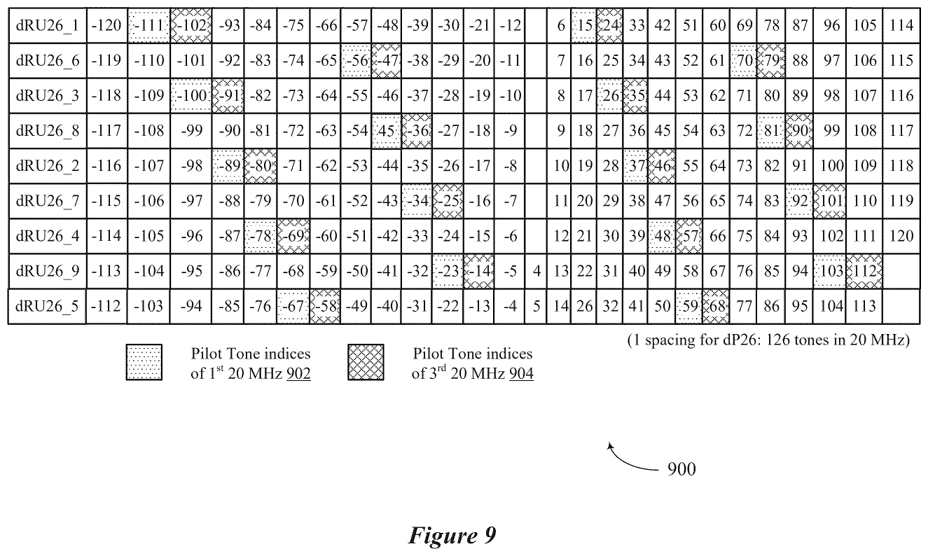

FIG. 9 shows an example of a pilot tone design 900 that supports techniques for tone mapping for 60 MHz distribution bandwidth. The pilot tone design 900 may implement aspects of wireless communication network 100, aspects of PDU 200, aspects of the PPDUs 300 and 400, or aspects of frequency diagrams 500 and 600. Aspects of the pilot tone design 900 may be implemented at or implemented by one or more wireless devices, which may be an example of the corresponding device(s) described herein. The wireless device may be an example of a UE, a STA, an AP, or a network entity.

In some examples, to address the pilot tone stacking from the spreading and interleaving of the first 20 MHz dRU tone plan, the second 20 MHz tone plan, and the third 20 MHz dRU tone plan, the relative pilot tone locations in the 20 MHz tone plans may be slightly adjusted for the dRU26 and mapped to the 60 MHz distribution bandwidth. For example, a set of pilot tones for a dRU26 of the first 20 MHz dRU tone plan may use the existing pilot tone locations as illustrated in FIG. 7. A set of pilot tones for a dRU26 of the third 20 MHz dRU tone plan may be shifted to the right or the left (such as offset relative to the set of pilot tones for the dRU26 of the first 20 MHz dRU tone plan) and mapped to the 60 MHz distribution bandwidth. A set of pilot tones for a dRU26 of the second 20 MHz dRU tone plan may be shifted to the right or the left (such as offset relative to the set of pilot tones for the dRU26 of the first 20 MHz dRU tone plan and offset relative to the set of pilot tones for the dRU26 of the third 20 MHz dRU tone plan) and mapped to the 60 MHz distribution bandwidth.

FIG. 9 illustrates one example of adjusting the relative pilot tone locations for dRU26 of the three 20 MHz tone plans. The pilot tone indices of the first 20 MHz dRU 902 may use the pilot tone locations as illustrated in FIG. 7. The pilot tone indices of the third 20 MHz dRU 904 may be shifted to the right by one relative tone location in dRU26 (such as relative offset by one tone from the pilot tone of the first 20 MHz dRU). The pilot tone indices of the second 20 MHz dRU (not shown in FIG. 9) may be shifted to the right or the left by two relative tone locations (such as relative offset by two tones from the pilot tone of the first 20 MHz dRU). In some implementations, the pilot tones of the first 20 MHz dRU may use the pilot tone locations as illustrated in FIG. 7; the pilot tones of the third 20 MHz dRU may be shifted to the right by one relative tone location; the pilot tones of the second 20 MHz dRU may be shifted to the left by one relative tone location. The advantage of the relative offset for the pilot tone locations of the second 20 MHz dRU and the third 20 MHz dRU is the fixed pilot separation patterns may be maintained; however, after shifting, some pilot may be the last or the first tone in the dRU26. The relative offset may ensure that the pilot tones associated with the dRU26 are evenly distributed across the wireless channel or otherwise distributed in a manner that is more robust against interference on the wireless channel. For example, evenly distributing the pilot tones over the wireless channel increases the likelihood that a receiving device will receive at least some of the pilot tones even if it experiences a deep fade in one or more localized regions of the wireless channel.

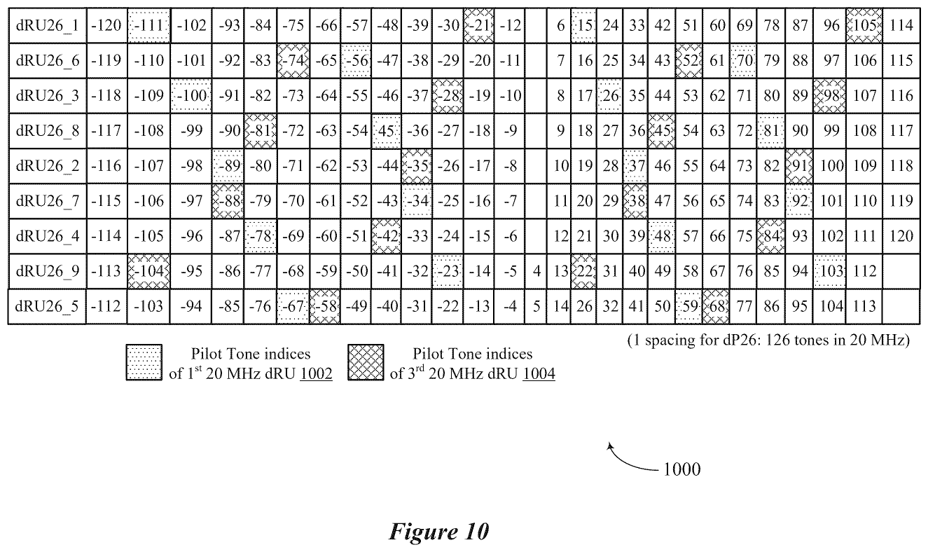

FIG. 10 shows an example of a pilot tone design 1000 that supports techniques for tone mapping for 60 MHz distribution bandwidth. The pilot tone design 1000 may implement aspects of wireless communication network 100, aspects of PDU 200, aspects of the PPDUs 300 and 400, or aspects of frequency diagrams 500 and 600. Aspects of the pilot tone design 1000 may be implemented at or implemented by one or more wireless devices, which may be an example of the corresponding device(s) described herein. The wireless device may be an example of a UE, a STA, an AP, or a network entity.

FIG. 10 illustrates one example of adjusting the relative pilot tone locations for dRU26 of the three 20 MHz tone plans. The pilot tone indices of the first 20 MHz dRU 1002 may use the pilot tone locations as illustrated in FIG. 7. The pilot tone indices of the third 20 MHz dRU 1004 may be generated as a relative position with respect to the last tone (such as tone 26) in dRU26. The pilot tone indices of the second 20 MHz dRU may be shifted to the right or the left by two relative tone locations (such as relative offset by two tone from the pilot tone of the first 20 MHz dRU).

FIG. 10 illustrates the pilot tones indices of the first 20 MHz dRU 1002 that use the pilot tone locations as illustrated in FIG. 7. The pilot tone indices of the third 20 MHz dRU 1004 may be generated as a relative position with respect to the last tone (such as tone 26). The pilot tone indices of the second 20 MHz dRU may be shifted to the right or the left by two relative tone locations from the first 20 MHz dRU (such as relative offset by two tones from the pilot tone of the first 20 MHz dRU). The advantage of the relative offset for the pilot tone locations of the third 20 MHz dRU is a maintained reversed fixed pilot separation patterns as existing pilots; however, after shifting, smaller pilot spacing in the 20 MHz may exist and may use more smoothing filtering modes. The relative offset may ensure that the pilot tones associated with the dRU26 are evenly distributed across the wireless channel or otherwise distributed in a manner that is more robust against interference on the wireless channel. For example, evenly distributing the pilot tones over the wireless channel increases the likelihood that a receiving device will receive at least some of the pilot tones even if it experiences a deep fade in one or more localized regions of the wireless channel.

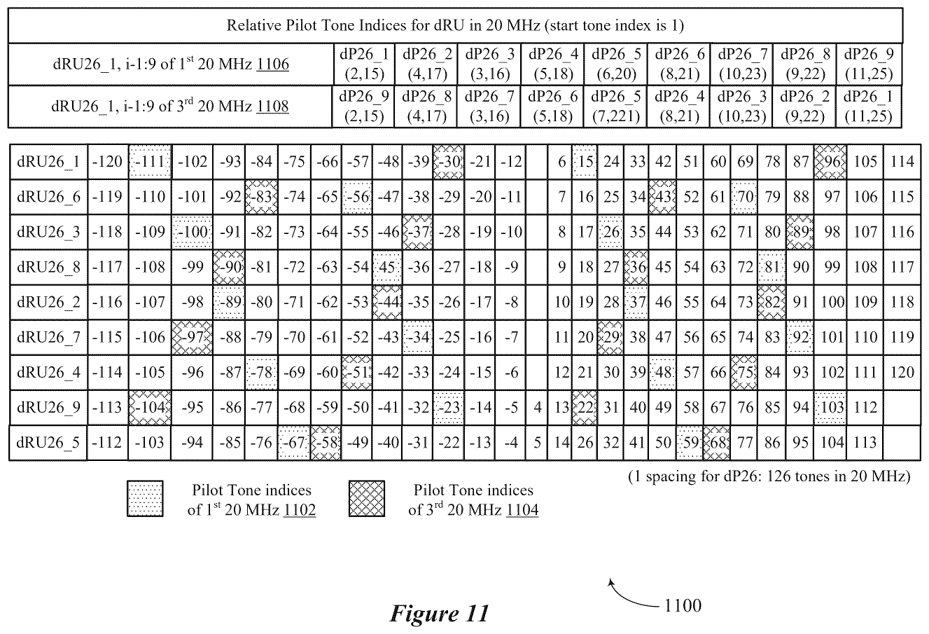

FIG. 11 shows an example of a pilot tone design 1100 that supports techniques for tone mapping for 60 MHz distribution bandwidth. The pilot tone design 1100 may implement aspects of wireless communication network 100, aspects of PDU 200, aspects of the PPDUs 300 and 400, or aspects of frequency diagrams 500 and 600. Aspects of the pilot tone design 1100 may be implemented at or implemented by one or more wireless devices, which may be an example of the corresponding device(s) described herein. The wireless device may be an example of a UE, a STA, an AP, or a network entity.

FIG. 11 illustrates one example of adjusting the relative pilot tone locations for dRU26 of the three 20 MHz tone plans. The pilot tone indices of the first 20 MHz dRU 1102 may use the pilot tone locations as illustrated in FIG. 7. The pilot tone indices of the third 20 MHz dRU 1104 may be generated by reversing the dRU indices in the relative pilot location table to generate new pilot locations. For example, FIG. 11 illustrates the relative pilot tone indices for dRU-1 of the first 20 MHz 1106 and the relative pilot tone indices for dRU-1 of the third 20 MHz 1108 after reversing. The pilot tone indices of the second 20 MHz dRU may be shifted to the right or the left by two relative tone locations (such as relative offset by two tone from the pilot tone of the first 20 MHz dRU). The advantage of the relative offset for the pilot tone locations with indices reversed is the fixed pilot separation patterns may be maintained but for a different dRU26 index; however, after shifting using reversed indices, a smaller pilot tone spacing in 20 MHz may exist using the new set of pilot tones.

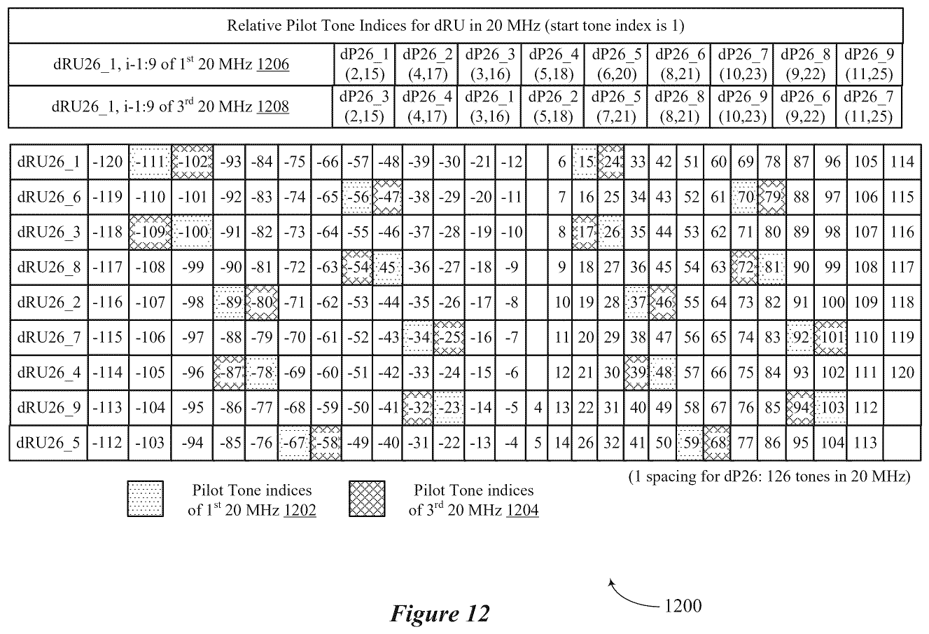

FIG. 12 shows an example of a pilot tone design 1200 that supports techniques for tone mapping for 60 MHz distribution bandwidth. The pilot tone design 1200 may implement aspects of wireless communication network 100, aspects of PDU 200, aspects of the PPDUs 300 and 400, or aspects of frequency diagrams 500 and 600. Aspects of the pilot tone design 1200 may be implemented at or implemented by one or more wireless devices, which may be an example of the corresponding device(s) described herein. The wireless device may be an example of a UE, a STA, an AP, or a network entity.

FIG. 12 illustrates one example of adjusting the relative pilot tone locations for dRU26 of the three 20 MHz tone plans. The pilot tone indices of the first 20 MHz dRU 1202 may use the pilot tone locations as illustrated in FIG. 7. The pilot tone indices of the third 20 MHz dRU 1204 may be generated by shifting within the four dRU26s (such as 1/2/3/4, 6/7/8/9). The shifting within the four dRU26s may address the result of the shifting in FIG. 9 resulting in some pilot tones being the first or the last tone in RU26. For example, FIG. 12 illustrates the relative pilot tone indices for dRU−1 of the first 20 MHz 1206 and the relative pilot tone indices for dRU−1 of the third 20 MHz 1208 after shifting within the four dRU26s. The pilot tone indices of the second 20 MHz dRU may be shifted to the right or the left by two relative tone locations (such as relative offset by two tone from the pilot tone of the first 20 MHz dRU). The advantage of the relative offset for the pilot tone locations with indices shifting within is the fixed pilot separation patterns may be maintained but for a different dRU26 index; however, after shifting using reversed indices, a smaller pilot tone spacing in 20 MHz may exist using the new set of pilot tones.

In some implementations, the wireless device may not have a mechanism for the STF sequence for TB PPDU on the 60 MHz distribution bandwidth. In some examples, an 80 MHz STF sequence for TB PPDU may be used for the 60 MHz DBW transmission, with STF tones populated only over the non-punctured portion of the 80 MHz bandwidth that corresponds to the multiple resource unit 484+242 (such as K_{STF,484+242}). STFs are generally used for automatic gain control (AGC) and carrier frequency (DC) estimation at a receiving device. For example, a transmitting device may transmit a known pattern of symbols, in an STF, to the receiving device. The receiving device may use its knowledge of the symbol pattern and its periodicity in the received STF (also referred to as an “STF sequence”) to estimate the power of the received signals and perform DC estimation. Further, the receiving device may dynamically adjust the gain of its amplifiers based on the estimated power of the STF and correct the DC of the received signals to ensure more accurate reception of the data portion of the PPDU.

In some implementations, the wireless device may not have a mechanism for a dRU index-based CSD assignment for 60 MHz distribution bandwidth transmission. For example, a global CSD index assignment table for 60 MHz dRU may not be available. Global CSD for dRU UHR-STF may help avoid an unintentional beamforming issue. dRU index-based global CSD assignment method and design may be used for the 20 MHz dRU, the 40 MHz dRU, and the 80 MHz dRU in order to minimize overall CSD value collision and to contribute no additional signaling overhead. The 60 MHz distribution bandwidth may not currently have an associated global CSD index assignment table. In some implementations, the global CSD assignment for 60 MHz dRU may be based on the dRU index using the CSD index pattern of dRU_1 or dRU_2 in dRU 40 MHz distribution bandwidth. In some implementations, the global CSD assignment for 60 MHz dRU may be based on the dRU index using the CSD index pattern of dRU_1, dRU_2, dRU_3, or dRU_4 in dRU 80 MHz distribution bandwidth. For example, one or more CSDs may be respectively applied to a plurality of dRUs of the PPDU in accordance with a first CSD index pattern defined for a first 20 MHz of a 40 MHz distributed bandwidth and a second CSD index pattern defined for a second 20 MHz of the 40 MHz distributed bandwidth. For example, one or more CSDs may be respectively applied to a plurality of dRUs of the PPDU in accordance with a CSD index pattern defined for one or more of a 60 MHZ portion of an 80 MHz distributed bandwidth, a 40 MHz portion of the 80 MHz distributed bandwidth, and a 20 MHz portion of the 80 MHz distributed bandwidth. In some implementations, a new global CSD assignment for dRU_1, dRU_2, dRU_3 (such as a plurality of global CSD assignment index values associated with the 60 MHz distribution bandwidth) may be designed.

Table 2 illustrate the cyclic shift values for VHT modulated fields of the PPDU. The global CSD index is 1, 2, 3, 4, 5, 6, 7, and 8. The eight CSD values for index 1, 2, 3, 4, 5, 6, 7, and 8 are [0-400-200-600-350-650-100-750] (ns) respectively, that will be used for global CSD assignment for dRU transmission.

TABLE 2
Cyclic Shift Values for the VHT Modulated Fields of a PPDU

| Total | | | | | | | | |
|---|---|---|---|---|---|---|---|---|
| number of | | | | | | | | |
| space-time | Cyclic Shift for space-time stream n (ns) | | | | | | | |
| streams | 1 | 2 | 3 | 4 | 5 | 6 | 7 | 8 |
| 1 | 0 | — | — | — | — | — | — | — |
| 2 | 0 | −400 | — | — | — | — | — | — |
| 3 | 0 | −400 | −200 | — | — | — | — | — |
| 4 | 0 | −400 | −200 | −600 | — | — | — | — |
| 5 | 0 | −400 | −200 | −600 | −350 | — | — | — |
| 6 | 0 | −400 | −200 | −600 | −350 | −650 | — | — |
| 7 | 0 | −400 | −200 | −600 | −350 | −650 | −100 | — |
| 8 | 0 | −400 | −200 | −600 | −350 | −650 | −100 | −750 |

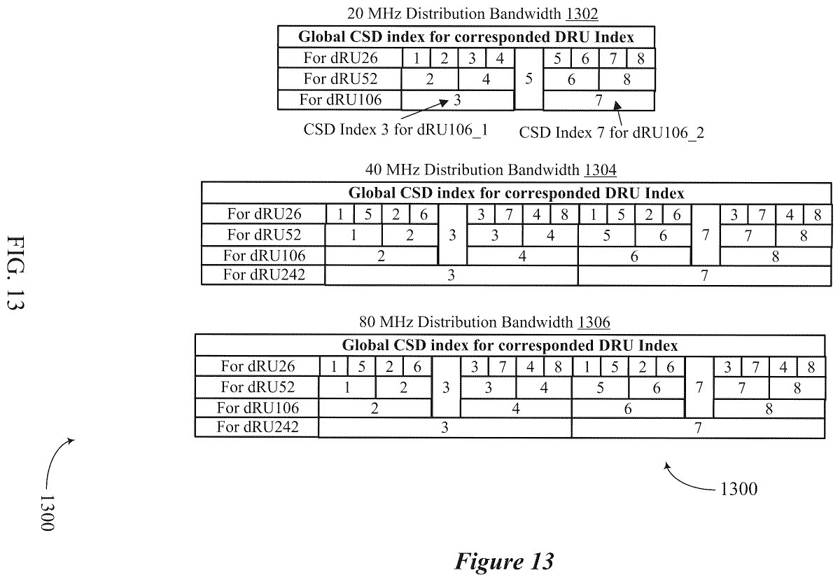

FIG. 13 shows an example of a global CSD index assignment diagram 1300 for a 20 MHz, a 40 MHz, and a 80 MHz distributed bandwidth The global CSD index assignment diagram 1300 may implement aspects of wireless communication network 100, aspects of PDU 200, aspects of the PPDUs 300 and 400, or aspects of frequency diagrams 500 and 600. Aspects of the global CSD index assignment diagram 1300 may be implemented at or implemented by one or more wireless devices, which may be an example of the corresponding device(s) described herein. The wireless device may be an example of a UE, a STA, an AP, or a network entity.

The global CSD index assignment diagram 1300 shows the global CSD index assignment for a 20 MHz distribution bandwidth 1302, a 40 MHz distribution bandwidth 1304, and an 80 MHz distribution bandwidth 1306.

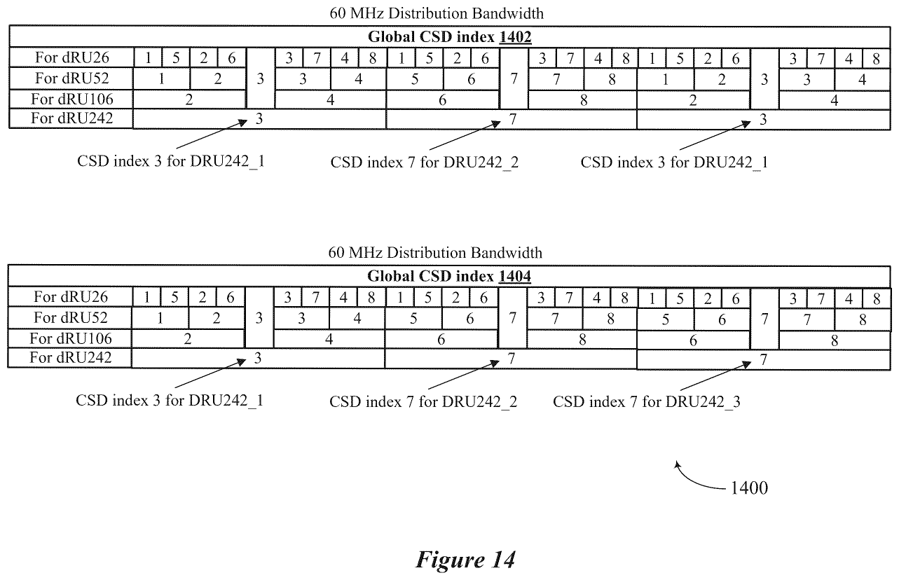

FIG. 14 shows an example of a global CSD index assignment diagram 1400 that supports techniques for tone mapping for 60 MHz distribution bandwidth. The global CSD index assignment diagram 1400 may implement aspects of wireless communication network 100, aspects of PDU 200, aspects of the PPDUs 300 and 400, or aspects of frequency diagrams 500 and 600. Aspects of the global CSD index assignment diagram 1400 may be implemented at or implemented by one or more wireless devices, which may be an example of the corresponding device(s) described herein. The wireless device may be an example of a UE, a STA, an AP, or a network entity.

The global CSD index assignment diagram 1400 shows the global CSD index assignment for the 60 MHz distribution bandwidth. In some implementations, the global CSD assignment for 60 MHz dRU may be based on the CSD index pattern of dRU_1 of the first 20 MHz of the 40 MHz distribution bandwidth or the CSD index pattern of the dRU_2 of the second 20 MHz of the 40 MHz distribution bandwidth. For example, one or more CSDs may be respectively applied to a plurality of dRUs of the PPDU in accordance with a first CSD index pattern defined for a first 20 MHz of a 40 MHz distributed bandwidth and a second CSD index pattern defined for a second 20 MHz of the 40 MHz distributed bandwidth.

FIG. 14 illustrates an example of a CSD index 1402 for the 60 MHz distribution bandwidth. The CSD index 1402 for the 60 MHz distribution bandwidth may apply the CSD index pattern of dRU_1 from the first 20 MHz of the 40 MHz distribution bandwidth for the first 20 MHz of the 60 MHz distribution bandwidth, may apply dRU_2 from the second 20 MHz of the 40 MHz distribution bandwidth for the second 20 MHz of the 60 MHz distribution bandwidth, and may apply the CSD index pattern of dRU_1 from the first 20 MHz of the 40 MHz distribution bandwidth for the third 20 MHz of the 60 MHz distribution bandwidth.

FIG. 14 illustrates another example of a CSD index 1404 for the 60 MHz distribution bandwidth. The CSD index 1404 for the 60 MHz distribution bandwidth may apply the CSD index pattern of dRU_1 from the first 20 MHz of the 40 MHz distribution bandwidth for the first 20 MHz of the 60 MHz distribution bandwidth, may apply dRU_2 from the second 20 MHz of the 40 MHz distribution bandwidth for the second 20 MHz of the 60 MHz distribution bandwidth, and may apply the CSD index pattern of dRU_2 from the second 20 MHz of the 40 MHz distribution bandwidth for the third 20 MHz of the 60 MHz distribution bandwidth.

In some implementations, the dRU26 may not be supported for the 60 MHz distribution bandwidth. The examples of the CSD index 1402 and the CSD index 1404 may be applicable to the situation with no support for dRU26 by removing the dRU26 portion from the respective indices.

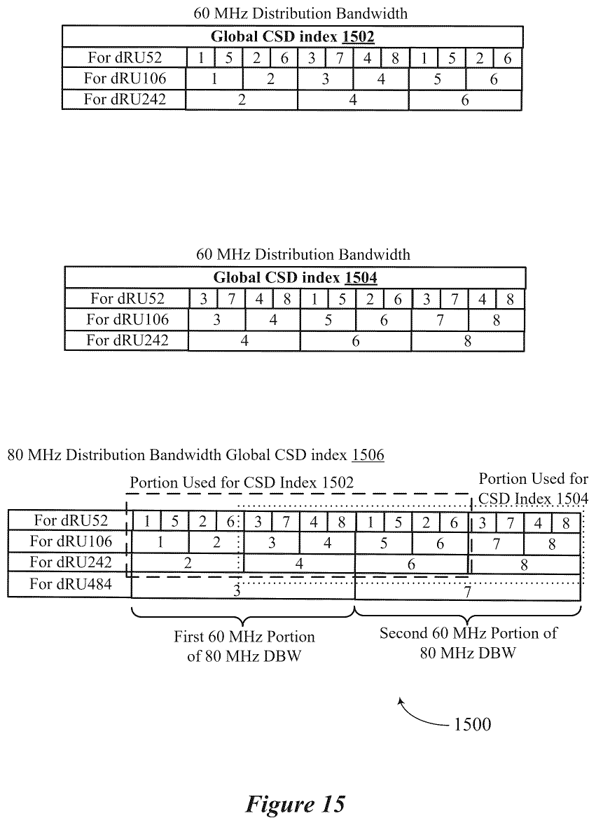

FIG. 15 shows examples of global CSD index assignment diagrams 1500 that support techniques for tone mapping for 60 MHz distribution bandwidth. The global CSD index assignment diagrams 1500 may implement aspects of wireless communication network 100, aspects of PDU 200, aspects of the PPDUs 300 and 400, or aspects of frequency diagrams 500 and 600. Aspects of the global CSD index assignment diagrams 1500 may be implemented at or implemented by one or more wireless devices, which may be an example of the corresponding device(s) described herein. The wireless device may be an example of a UE, a STA, an AP, or a network entity.

The global CSD index assignment diagrams 1500 show the global CSD index assignment for the 60 MHz distribution bandwidth. In some implementations, the global CSD assignment for 60 MHz dRU may reuse the CSD index pattern of the 80 MHz distribution bandwidth. The global CSD assignment for 60 MHz dRU may be based on the CSD index pattern of a 60 MHz portion of the 80 MHz distribution bandwidth. For example, the CSD index 1502 or global CSD assignment for a 60 MHz dRU may be based on the CSD index pattern of a first 60 MHz portion of the 80 MHz distribution bandwidth global CSD index 1506, and the CSD index 1502 includes a set of CSD indices associated with a dRU52, a dRU106, and a dRU242 of the first 60 MHz of the 80 MHz distribution bandwidth. For example, the CSD index 1504 or the global CSD assignment for a 60 MHz dRU may be based on the CSD index pattern of a second 60 MHz portion of the 80 MHz distribution bandwidth global CSD index 1506, and the CSD index 1504 includes a set of CSD indices associated with a dRU52, a dRU106, and a dRU242 of the second 60 MHz of the 80 MHz distribution bandwidth. The one or more CSDs may be respectively applied to a plurality of dRUs of the PPDU in accordance with the CSD index 1502 or the CSD index 1504 defined for the 60 MHZ distributed bandwidth based on the 60 MHz portion of the 80 MHz distribution bandwidth global CSD index.

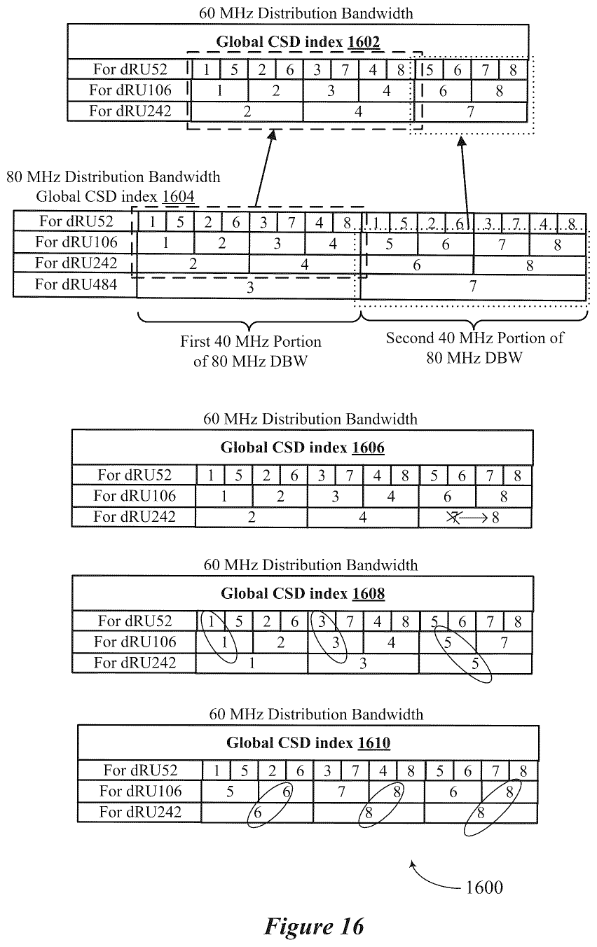

FIG. 16 shows examples of global CSD index assignment diagrams 1600 that support techniques for tone mapping for 60 MHz distribution bandwidth. The global CSD index assignment diagrams 1600 may implement aspects of wireless communication network 100, aspects of PDU 200, aspects of the PPDUs 300 and 400, or aspects of frequency diagrams 500 and 600. Aspects of the global CSD index assignment diagrams 1600 may be implemented at or implemented by one or more wireless devices, which may be an example of the corresponding device(s) described herein. The wireless device may be an example of a UE, a STA, an AP, or a network entity. The global CSD index assignment diagrams 1600 show the global CSD index assignment for the 60 MHz distribution bandwidth.

In some implementations, the global CSD assignment for the 60 MHz dRU may be based on the CSD index pattern of two 40 MHz portions of the 80 MHz distribution bandwidth. For example, the CSD index 1602 or the global CSD assignment for a 60 MHz dRU may reuse or be based on the CSD index pattern of a first 40 MHz portion of the 80 MHz distribution bandwidth global CSD index 1604 and a second 40 MHz portion of the 80 MHz distribution bandwidth global CSD index 1604. The 60 MHz CSD index table may be constructed using the CSD indices associated with the dRU52, dRU106, and dRU242 for the first 40 MHz portion of the 80 MHz distribution bandwidth global CSD index 1604 and using the CSD indices associated with the dRU106, dRU242, and dRU484 for the second 40 MHz portion of the 80 MHz distribution bandwidth global CSD index 1604. The CSD indices associated with the dRU106 for the first 40 MHz portion of the 80 MHz distribution bandwidth global CSD index 1604 (such as 1, 2, 3, and 4) are complementary to the CSD indices associated with the dRU106 for the second 40 MHz portion of the 80 MHz distribution bandwidth global CSD index 1604 (such as 5, 6, 7, and 8). For the global CSD index 1602, the CSD indices associated with the dRU106 for the first 40 MHz portion of the 60 MHz distribution bandwidth global CSD index 1602 (such as 1, 2, 3, and 4) are complementary to the CSD indices associated with the dRU52 for the last 20 MHz of the 60 MHz distribution bandwidth (such as 5, 6, 7, and 8). The complementary nature of these CSD indices may minimize the CSD index collision between existing set for the left two dRU242 and the newly added set for the 3rd dRU242 and underneath.

In some implementations, the global CSD assignment for 60 MHz dRU may be based on the CSD index pattern of the two 40 MHz portions of the 80 MHz distribution bandwidth. For example, the CSD index 1606 or the global CSD assignment for a 60 MHz dRU may reuse or be based on the CSD index pattern of a first 40 MHz portion of the 80 MHz distribution bandwidth global CSD index 1604 and a second 40 MHz portion of the 80 MHz distribution bandwidth global CSD index 1604. The dRU52 of the CSD index 1606 may be the same as the dRU52 of the CSD index 1602, and the dRU106 of the CSD index 1606 may be the same as the dRU106 of the CSD index 1602. For the dRU242 of the CSD index 1606, the CSD indices are 2, 4, and 8 (such as CSD index 8 replaces CSD index 7 of dRU242 of the CSD index 1602).

In some implementations, the global CSD assignment for 60 MHz dRU may be based on the CSD index pattern of two 40 MHz portions of the 80 MHz distribution bandwidth. The CSD index 1608 or the global CSD assignment for a 60 MHz dRU may reuse or be based on the CSD index pattern of a first 40 MHz portion of the 80 MHz distribution bandwidth global CSD index 1604 and a second 40 MHz portion of the 80 MHz distribution bandwidth global CSD index 1604. The dRU52 of the CSD index 1608 may be the same as the dRU52 of the CSD index 1602, and the CSD indices for dRU106 and dRU242 may be selected based on a left one rule. For the dRU106 of the CSD index 1608, the CSD index value may be selected as the left one in the corresponding dRU52s. For example, the CSD index value 1 may be selected for dRU106 based on the CSD index value 1 (such as left position) in dRU52. For the dRU242 of the CSD index 1608, the CSD index value may be selected as the left one in dRU106. For example, the CSD index value 1 may be selected for dRU242 based on the CSD index value 1 (such as left position) in dRU106. The left one rule allows the device to receive or maintain the CSD indices associated with the dRU52, and the device may construct the CSD indices for the dRU106 and dRU 242 based on the CSD indicates associated with the dRU52.

In some implementations, the global CSD assignment for 60 MHz dRU may be based on the CSD index pattern of two 40 MHz portions of the 80 MHz distribution bandwidth. The CSD index 1610 or the global CSD assignment for a 60 MHz dRU may reuse or be based on the CSD index pattern of a first 40 MHz portion of the 80 MHz distribution bandwidth global CSD index 1604 and a second 40 MHz portion of the 80 MHz distribution bandwidth global CSD index 1604. The dRU52 of the CSD index 1610 may be the same as the dRU52 of the CSD index 1602, and the CSD indices for dRU106 and dRU242 may be selected based on a right one rule. For the dRU106 of the CSD index 1610, the CSD index may be selected as the right one in the corresponding dRU52s. For example, the CSD index 5 may be selected for dRU106 based on the CSD index 5 (such as right position) in dRU52. For the dRU242 of the CSD index 1610, the CSD index may be selected as the right one in dRU106. For example, the CSD index 6 may be selected for dRU242 based on the CSD index 6 (such as right position) in dRU106. The right one rule allows the device to receive or maintain the CSD indices associated with the dRU52, and the device may construct the CSD indices for the dRU106 and dRU 242 based on the CSD indices associated with the dRU52.

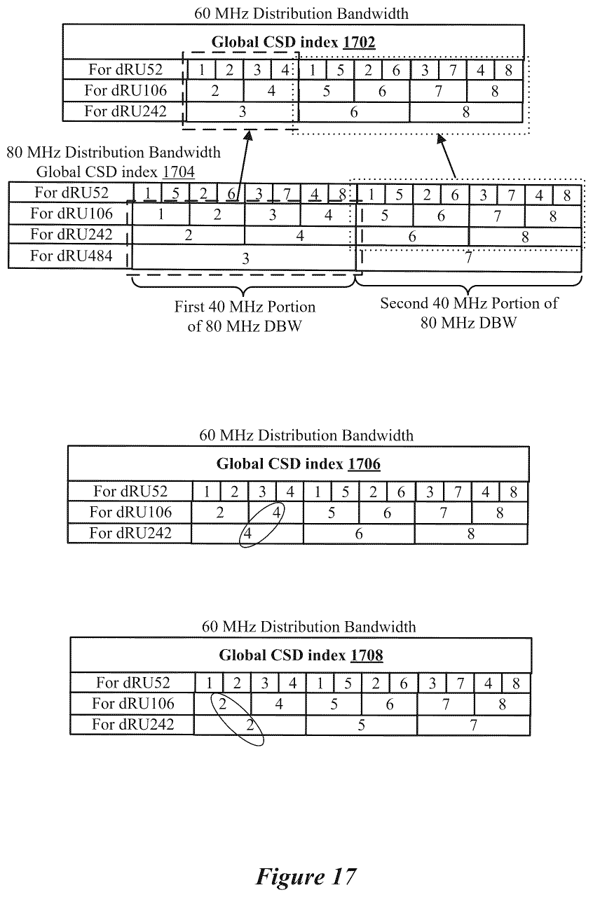

FIG. 17 shows examples of a global CSD index assignment diagrams 1700 that supports techniques for tone mapping for 60 MHz distribution bandwidth. The global CSD index assignment diagrams 1700 may implement aspects of wireless communication network 100, aspects of PDU 200, aspects of the PPDUs 300 and 400, or aspects of frequency diagrams 500 and 600. Aspects of the global CSD index assignment diagrams 1700 may be implemented at or implemented by one or more wireless devices, which may be an example of the corresponding device(s) described herein. The wireless device may be an example of a UE, a STA, an AP, or a network entity. The global CSD index assignment diagrams 1700 show the global CSD index assignment for the 60 MHz distribution bandwidth.

In some implementations, the global CSD assignment for the 60 MHz dRU may be based on the CSD index pattern of two 40 MHz portions of the 80 MHz distribution bandwidth. For example, the CSD index 1702 or the global CSD assignment for a 60 MHz dRU may reuse or be based on the CSD index pattern of a first 40 MHz portion of the 80 MHz distribution bandwidth global CSD index 1704 and a second 40 MHz portion of the 80 MHz distribution bandwidth global CSD index 1704. The 60 MHz CSD index table may be constructed using the CSD indices associated with the dRU106, dRU242, and dRU484 for the first 40 MHz portion of the 80 MHz distribution bandwidth global CSD index 1704 and using the CSD indices associated with the dRU52, dRU106, and dRU242 for the second 40 MHz portion of the 80 MHz distribution bandwidth global CSD index 1704. The CSD indices associated with the dRU106 for the first 40 MHz portion of the 80 MHz distribution bandwidth global CSD index 1704 (such as 1, 2, 3, and 4) are complementary to the CSD indices associated with the dRU106 for the second 40 MHz portion of the 80 MHz distribution bandwidth global CSD index 1704 (such as 5, 6, 7, and 8). For the global CSD index 1702, the CSD indices associated with the dRU52 for the first 20 MHz portion of the 60 MHz distribution bandwidth global CSD index 1702 (such as 1, 2, 3, and 4) are complementary to the CSD indices associated with the dRU106 for the last 40 MHz of the 60 MHz distribution bandwidth (such as 5, 6, 7, and 8).

In some implementations, the global CSD assignment for 60 MHz dRU may be based on the CSD index pattern of two 40 MHz portions of the 80 MHz distribution bandwidth. The CSD index 1706 or the global CSD assignment for a 60 MHz dRU may reuse or be based on the CSD index pattern of a first 40 MHz portion of the 80 MHz distribution bandwidth global CSD index 1704 and a second 40 MHz portion of the 80 MHz distribution bandwidth global CSD index 1704. The dRU52 of the CSD index 1706 may be the same as the dRU52 of the CSD index 1702, and the CSD indices for dRU106 and dRU242 may be selected based on a right one rule. For the dRU106 of the CSD index 1706, the CSD index may be selected as the right one in the corresponding dRU52s. For example, the CSD index value 2 may be selected for dRU106 based on the CSD index value 2 (such as right position) in dRU52. For the dRU242 of the CSD index 1706, the CSD index value may be selected as the right one in dRU106. For example, the CSD index value 4 may be selected for dRU242 based on the CSD index value 4 (such as right position) in dRU106. The right one rule allows the device to receive or maintain the CSD indices associated with the dRU52, and the device may construct the CSD indices for the dRU106 and dRU 242 based on the CSD indices associated with the dRU52.

In some implementations, the global CSD assignment for 60 MHz dRU may be based on the CSD index pattern of two 40 MHz portions of the 80 MHz distribution bandwidth. The CSD index 1708 or the global CSD assignment for a 60 MHz dRU may reuse or be based on the CSD index pattern of a first 40 MHz portion of the 80 MHz distribution bandwidth global CSD index 1704 and a second 40 MHz portion of the 80 MHz distribution bandwidth global CSD index 1704. The dRU52 of the CSD index 1708 may be the same as the dRU52 of the CSD index 1702, and the CSD indices for dRU106 may be the same as the dRU106 of the CSD index 1702. The CSD indices for dRU242 may be selected based on a left one rule. For the dRU242 of the CSD index 1708, the CSD index value may be selected as the left one in the corresponding dRU106s. For example, the CSD index value 2 may be selected for dRU242 based on the CSD index value 2 (such as left position) in dRU106.

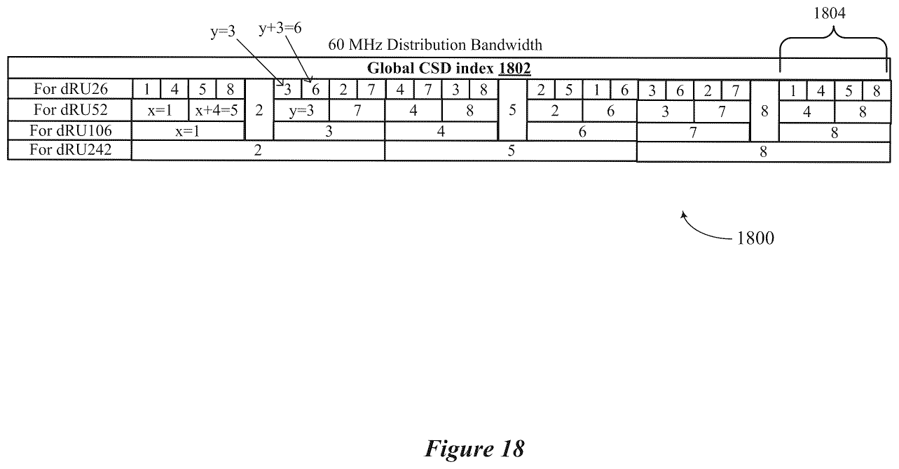

FIG. 18 shows an example of a global CSD index assignment diagram 1800 that supports techniques for tone mapping for 60 MHz distribution bandwidth. The global CSD index assignment diagram 1800 may implement aspects of wireless communication network 100, aspects of PDU 200, aspects of the PPDUs 300 and 400, or aspects of frequency diagrams 500 and 600. Aspects of the global CSD index assignment diagram 1800 may be implemented at or implemented by one or more wireless devices, which may be an example of the corresponding device(s) described herein. The wireless device may be an example of a UE, a STA, an AP, or a network entity.

The global CSD index assignment diagram 1800 shows the global CSD index assignment for the 60 MHz distribution bandwidth. In some implementations, the global CSD assignment for 60 MHz dRU may be based on a plurality of global CSD assignment index values associated with the 60 MHz distribution bandwidth. FIG. 18 illustrates an example of a CSD index 1802 for the 60 MHz distribution bandwidth. The CSD index 1802 is generated by allocating the CSD index 1˜8 on each dRU106 as shown in FIG. 18. For dRU242, the CSD index is 2 for dRU_1, the CSD index is 5 for dRU_2, and the CSD index is 8 for dRU_3. For dRU52, the respective CSD index may be determined as (x,x+4) mod 8, where x is the CSD index in dRU106. For dRU52, the respective CSD index may be determined as (y,y+3) mod 8, where y is the CSD index in dRU52. For the portion of the dRU_3 identified by reference number 1804, the CSD indices for dRU26 and dRU52 may not strictly follow the described rules due to only eight CSD index values are available; therefore, the values (1,4) and (5,8) may be assigned to dRU26 and the values (4,8) may be assigned to dRU52 to preserve the nested dRU structure and to minimize CSD value collisions.

In some implementations, the dRU26 may not be supported for the 60 MHz distribution bandwidth. The examples of the CSD index 1802 may be applicable to the situation with no support for dRU26 by removing the dRU26 portion from the respective CSD index 1802.

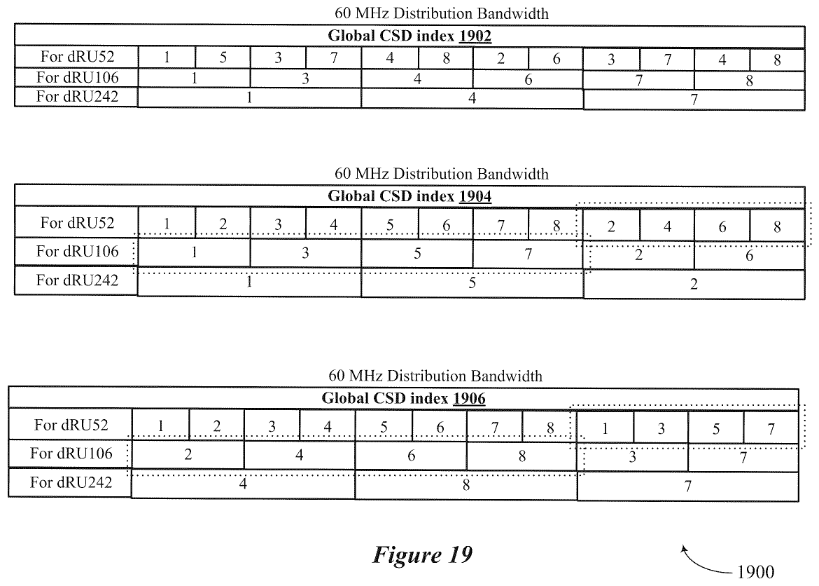

FIG. 19 shows examples of global CSD index assignment diagrams 1900 that supports techniques for tone mapping for 60 MHz distribution bandwidth. The global CSD index assignment diagrams 1900 may implement aspects of wireless communication network 100, aspects of PDU 200, aspects of the PPDUs 300 and 400, or aspects of frequency diagrams 500 and 600. Aspects of the global CSD index assignment diagram 1900 may be implemented at or implemented by one or more wireless devices, which may be an example of the corresponding device(s) described herein. The wireless device may be an example of a UE, a STA, an AP, or a network entity. The global CSD index assignment diagram 1900 shows the global CSD index assignment for the 60 MHz distribution bandwidth.

In some implementations, the global CSD assignment for 60 MHz dRU may be based on a plurality of global CSD assignment index values associated with the 60 MHz distribution bandwidth. FIG. 19 illustrates an example of a CSD index 1902 for the 60 MHz distribution bandwidth. The CSD index 1902 may be based on the CSD index 1802 with the index for the center dRU26 removed in each 20 MHz. For example, the CSD index 2, 5, and 8 for center dRU26s may be removed from the CSD index 1802 corresponding to the dRU52 and dRU106. The CSD index 1902 may be enhanced (such as optimized) for the dRU242 as compared to the CSD index 1802 to reduce CSD index collisions. For example, the CSD indices for dRU242 of the CSD index 1902 may be 1, 4, and 7 instead of 2, 5, and 8 of the CSD index 1802.

FIG. 19 illustrates an example of a CSD index 1904 for the 60 MHz distribution bandwidth. The CSD index 1904 may be based on a rules-based CSD design. For example, a first rule may indicate that the CSD indices of the first four dRU106 and the last four dRU52 complement each other, a second rule may indicate that the CSD index of dRU106 may be selected as the left one for its corresponding dRU52, and a third rule may indicate that the CSD index of dRU242 may be selected as the left one for its corresponding dRU106. For example, the CSD indices for dRU52 of the CSD index 1904 may be 1, 2, 3, 4, 5, 6, 7, 8, 2, 4, 6, and 8; the CSD indices for dRU106 of the CSD index 1904 may be 1, 3, 5, 7, 2, and 6; and the CSD indices for dRU242 of the CSD index 1904 may be 1, 5, and 2. For the CSD index 1904, the CSD indices of the first four dRU106 (such as 1, 3, 5, and 7) may complement the last four dRU52 (such as 2, 4, 6, and 8).

FIG. 19 illustrates an example of a CSD index 1906 for the 60 MHz distribution bandwidth. The CSD index 1906 may be based on a rules-based CSD design. For example, a first rule may indicate that the CSD indices of the first four dRU106 and the last four dRU52 should complement each other, a second rule may indicate that the CSD index of dRU106 should be selected as the right one for its corresponding dRU52, and a third rule may indicate that the CSD index of dRU242 should be selected as the right one for its corresponding dRU106. For example, the CSD indices for dRU52 of the CSD index 1906 may be 1, 2, 3, 4, 5, 6, 7, 8, 1, 3, 5, and 7; the CSD indices for dRU106 of the CSD index 1906 may be 2, 4, 6, 8, 3, and 7; and the CSD indices for dRU242 of the CSD index 1904 may be 4, 8, and 7. For the CSD index 1906, the CSD indices of the first four dRU106 (such as 2, 4, 6, and 8) may complement the last four dRU52 (such as 1, 3, 5, and 7). The structure of the table for CSD index 1906 may be aligned with 40 MHz+20 MHz with CSD collision reduced. The 40 MHz part may be the same as 40 MHz CSD assignment table for dRU52 and dRU106, with CSD index down selection modified for dRU242s to leave enough CSD indices for 20 MHz part. The 20 MHz part may use the complementary index set to minimize the CSD collision. The CSD indices of “the first four dRU106” in the 40 MHz part and “the last four dRU52” in the 20 MHz part complement each other to avoid CSD collision in the index down selection for larger dRUs. For the index down selection for larger dRU, the right one for the smaller dRUs may be chosen, and using the same pattern may save memory. The CSD index of dRU106 may be selected as the right one for its corresponding dRU52s. The CSD index of dRU242 may be selected as the right one for its corresponding dRU106s. The indices for dRU52 may be saved, and every other index is for dRU106 and every fourth one is for dRU242.

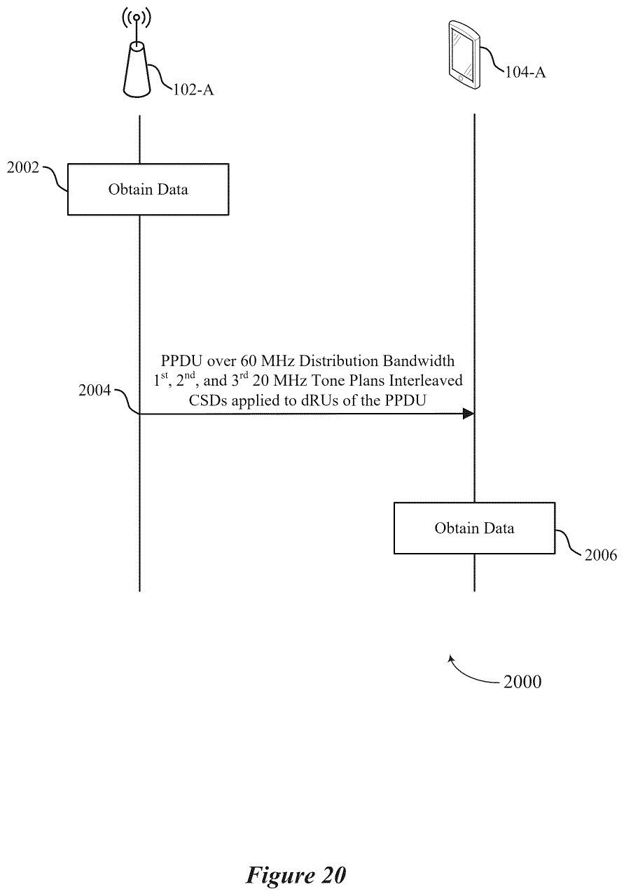

FIG. 20 shows an example of a process flow 2000 that supports techniques for tone mapping for 60 MHz distribution bandwidth. The process flow 2000 may implement or may be implemented by aspects of the wireless communication network 100. For example, the process flow 2000 may include a transmitting wireless device 102-a and a receiving wireless device 104-a, which may be examples of the wireless devices described herein. The transmitting wireless device 102-a and the receiving wireless device 104-a may be an example of a UE, a STA, an AP, or a network entity. In the following description of the process flow 2000, the operations between the transmitting wireless device 102-a and the receiving wireless device 104-a may be transmitted in a different order than the example order shown, or the operations performed by the transmitting wireless device 102-a and the receiving wireless device 104-a may be performed in different orders or at different times. Some operations also may be omitted from the process flow 2000, and other operations may be added to the process flow 2000.

At 2002, the transmitting wireless device 102-a may obtain data for transmission in a PLCP PPDU.

At 2004, the transmitting wireless device 102-a may transmit, to the receiving wireless device 104-a, the PPDU over an 80 MHz distribution bandwidth. The 80 MHz distribution bandwidth may be punctured providing a 60 MHz distribution bandwidth.

In some implementations, a first 20 MHz dRU tone plan, a second 20 MHz dRU tone plan, and a third 20 MHz dRU tone plan may be interleaved over the 60 MHz distribution bandwidth. In some implementations, a first tone of the second 20 MHz dRU tone plan may be offset relative to a first tone of the first 20 MHz dRU by two tones. In some examples, a first tone of the third 20 MHz dRU tone plan may be offset relative to the first tone of the first 20 MHz dRU by one tone.

In some implementations, a set of twenty-six tone dRU may be associated with each of the first 20 MHz dRU tone plan, the second 20 MHz dRU tone plan, and the third 20 MHz dRU tone plan, and the transmission of the PPDU abstains from using the set of the twenty-sixth tone dRU.

In some implementations, a first set of pilot tones for a first twenty-six tone dRU may be associated with the first 20 MHz dRU tone plan, a second set of pilot tones for a second twenty-six tone dRU may be associated with the second 20 MHz dRU tone plan, and a third set of pilot tones for a third twenty-six tone dRU may be associated with the third 20 MHz dRU tone plan. The second set of pilot tones may be offset relative to the first set of pilot tones, and the third set of pilot tones may be offset relative to the first set of pilot tones. The second set of pilot tones may be offset relative to the first set of pilot tones by one tone in twenty-six distributed tones for the second twenty-six tone dRU. The first set of pilot tones may be offset relative to tone one, and the third set of pilot tones may be offset relative to tone twenty-six in twenty-six distributed tones for the third twenty-six tone dRU. The first set of pilot tones may be offset relative to tone one, and the third set of pilot tones may be offset with associated indices of the third twenty-six tone reversed. The first set of pilot tones may be offset relative to tone one, and the third set of pilot tones may be offset within indices one, two, three, and four and within indices six, seven, eight, and nine.

In some implementations, a sequence of values representing a STF of the PPDU may be based on a STF sequence associated with triggered transmission and an 80 MHz bandwidth, and the values may be populated only over a non-punctured portion of the 80 MHz bandwidth that corresponds to a multiple resource unit four hundred eighty-four plus two hundred forty-two.

In some implementations, one or more CSDs may be respectively applied to a plurality of dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a plurality of global CSD assignment index values associated with the 60 MHz distribution bandwidth. A first set of one or more CSDs may be assigned to a first set of one or more dRUs associated with a first 20 MHz of the 60 MHz distribution bandwidth in accordance with the first CSD index pattern. A second set of one or more CSDs may be assigned to a second set of one or more dRUs associated with a second 20 MHz of the 60 MHz distribution bandwidth in accordance with the second CSD index pattern. A third set of one or more CSDs may be assigned to a third set of one or more dRUs occupying a third 20 MHz of the 60 MHz distribution bandwidth in accordance with either the first CSD index pattern or the second CSD index pattern.

In some implementations, one or more CSDs may be respectively applied to a plurality of dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth. In some examples, the first CSD index pattern includes a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth. In some examples, the second CSD index pattern includes a first set of CSD indices associated with a dRU52, a dRU106, and a dRU242 of the first 40 MHz and a second set of CSD indices associated with a dRU106, a dRU242, and a dRU484 of the second 40 MHz. In some examples, the second CSD index pattern includes a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

In some examples, the 60 MHz distribution bandwidth may include three dRUs of 242 tones, and the global CSD assignment index values may include a CSD index 2 assigned to a first 242 tone dRU associated with a first 20 MHz of the 60 MHz distribution bandwidth, a global CSD index 5 assigned to a second 242 tone dRU associated with a second 20 MHz of the 60 MHz bandwidth, and a global CSD index 8 assigned to a third 242 tone dRU associated with a third 20 MHz of the 60 MHz distribution bandwidth. In some implementations, the 60 MHz distribution bandwidth may include three dRUs of 106 tones, and the global CSD assignment index values may include CSD indices 1, 2 and 3 assigned to a first 106 tone dRU associated with a first 20 MHz of the 60 MHz distribution bandwidth, global CSD indices 4, 5, and 6 assigned to a second 106 tone dRU associated with a second 20 MHz of the 60 MHz bandwidth, and global CSD indices 7 and 8 assigned to a third 106 tone dRU associated with a third 20 MHz of the 60 MHz distribution bandwidth. In some examples, the 60 MHz distribution bandwidth includes three dRUs of 52 tones, the global CSD assignment index values may include the CSD indices assigned to a first 52 tone dRU associated with a first 20 MHz of the 60 MHz distribution bandwidth based on the global CSD indices associated with the first 106 tone dRU, the CSD indices assigned to a second 52 tone dRU associated with a second 20 MHz of the 60 MHz distribution bandwidth based on the global CSD indices associated with the second 106 tone dRU, the CSD indices assigned to a third 52 tone dRU associated with a third 20 MHz of the 60 MHz distribution bandwidth based on the global CSD indices associated with the third 106 tone dRU. In some implementations, the 60 MHz distribution bandwidth includes three dRUs of 26 tones, the global CSD assignment index values may include the CSD indices assigned to a first 26 tone dRU associated with a first 20 MHz of the 60 MHz distribution bandwidth based on the global CSD indices associated with the first 52 tone dRU, the CSD indices assigned to a second 26 tone dRU associated with a second 20 MHz of the 60 MHz distribution bandwidth based on the global CSD indices associated with the second 52 tone dRU, the CSD indices assigned to a third 26 tone dRU associated with a third 20 MHz of the 60 MHz distribution bandwidth based on the global CSD indices associated with the third 52 tone dRU.

At 2006, the receiving wireless device 104-a may obtain data from the received PPDU.

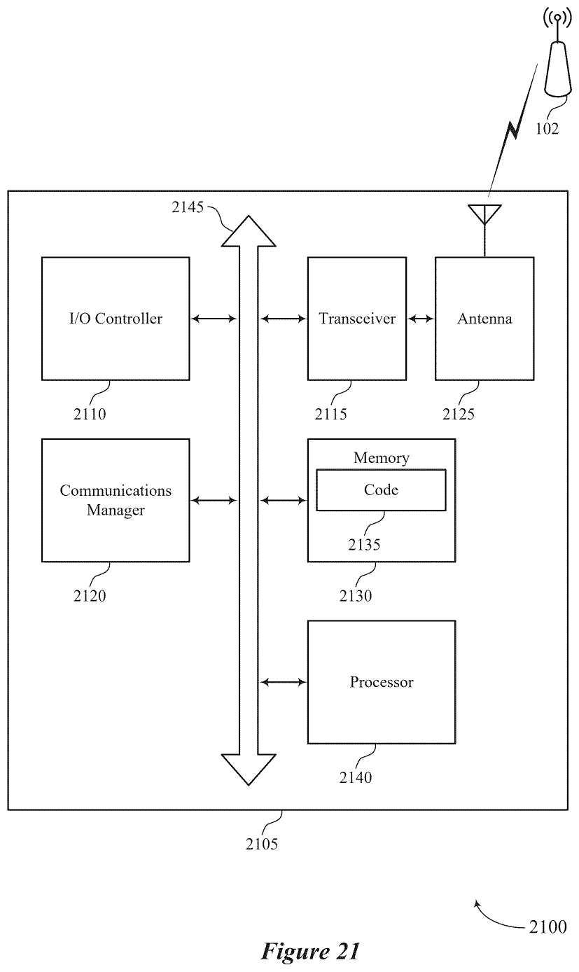

FIG. 21 shows a diagram of a system 2100 including a device 2105 that supports techniques for tone mapping for 60 MHz distribution bandwidth. The device 2105 may include components for bi-directional voice and data communications including components for transmitting and receiving communications, such as a communications manager 2120, an I/O controller, such as an I/O controller 2110, a transceiver 2115, one or more antennas 2125, at least one memory 2130, code 2135, and at least one processor 2140. These components may be in electronic communication or otherwise coupled (such as operatively, communicatively, functionally, electronically, electrically) via one or more buses (such as a bus 2145).

The I/O controller 2110 may manage input and output signals for the device 2105. The I/O controller 2110 also may manage peripherals not integrated into the device 2105. In some implementations, the I/O controller 2110 may represent a physical connection or port to an external peripheral. In some implementations, the I/O controller 2110 may utilize an operating system such as iOS®, ANDROID®, MS-DOS®, MS-WINDOWS®, OS/2®, UNIX®, LINUX®, or another known operating system. In some other implementations, the I/O controller 2110 may represent or interact with a modem, a keyboard, a mouse, a touchscreen, or a similar device. In some implementations, the I/O controller 2110 may be implemented as part of a processor, such as the processor 2140. In some implementations, a user may interact with the device 2105 via the I/O controller 2110 or via hardware components controlled by the I/O controller 2110.

In some implementations, the device 2105 may include a single antenna. However, in some other implementations the device 2105 may have more than one antenna, which may be capable of concurrently transmitting or receiving multiple wireless transmissions. The transceiver 2115 may communicate bi-directionally via the one or more antennas 2125 using wired or wireless links as described herein. The transceiver 2115 may represent a wireless transceiver and may communicate bi-directionally with another wireless transceiver. The transceiver 2115 also may include a modem to modulate the packets and provide the modulated packets to one or more antennas 2125 for transmission, and to demodulate packets received from the one or more antennas 2125. The transceiver 2115, or the transceiver 2115 and one or more antennas 2125, may be an example of a transmitter, a receiver, or any combination thereof or component thereof, as described herein.

The memory 2130 may include RAM and ROM. The memory 2130 may store computer-readable, computer-executable, or processor-executable code, such as code 2135. The code 2135 may include instructions that, when executed by the processor 2140, cause the device 2105 to perform various functions described herein. In some implementations, the memory 2130 may include, among other things, a BIOS which may control basic hardware or software operation such as the interaction with peripheral components or devices.

The processor 2140 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 2140 may be configured to operate a memory array using a memory controller. In some other implementations, a memory controller may be integrated into the processor 2140. The processor 2140 may be configured to execute computer-readable instructions stored in a memory (such as the memory 2130) to cause the device 2105 to perform various functions (such as functions or tasks supporting physical protocol data unit for ambient power devices). The device 2105 or a component of the device 2105 may include a processor 2140 and memory 2130 coupled to the processor 2140, the processor 2140 and memory 2130 configured to perform various functions described herein.

The communications manager 2120 may support wireless communications in accordance with examples as disclosed herein. The communications manager 2120 is capable of, configured to, or operable to support a means for transmitting or receiving a PLCP PPDU over an 80 MHz, where the 80 MHz distribution bandwidth is punctured providing a 60 MHz distribution bandwidth.

By including or configuring the communications manager 2120 in accordance with examples as described herein, the device 2105 may support techniques for tone mapping for 60 MHz distribution bandwidth.

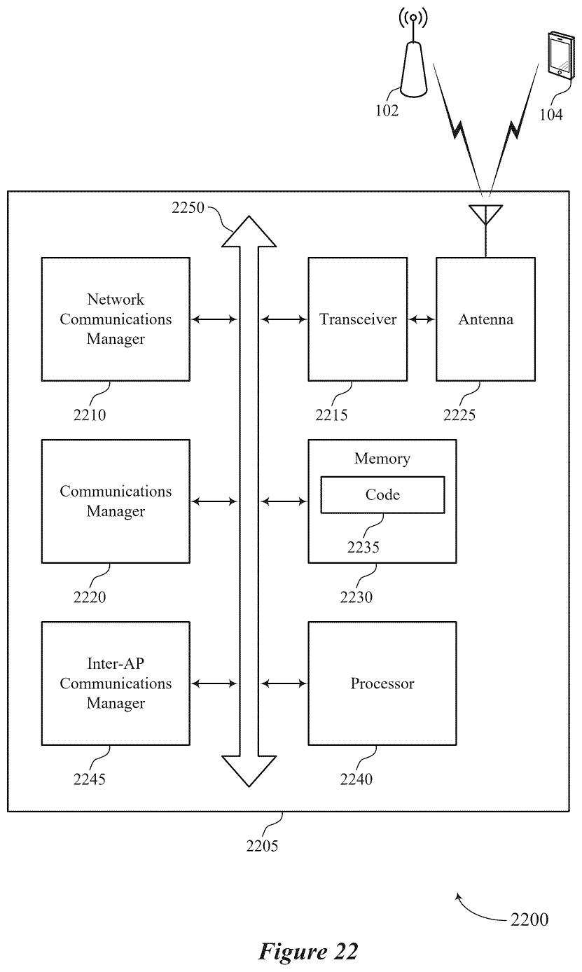

FIG. 22 shows a diagram of a system 2200 including a device 2205 that supports techniques for tone mapping for 60 MHz distribution bandwidth. The device 2205 may include components for bi-directional voice and data communications including components for transmitting and receiving communications, such as a communications manager 2220, a network communications manager 2210, a transceiver 2215, one or more antennas 2225, at least one memory 2230, code 2235, at least one processor 2240, and an inter-AP communications manager 2245. These components may be in electronic communication or otherwise coupled (such as operatively, communicatively, functionally, electronically, electrically) via one or more buses (such as a bus 2250).

The network communications manager 2210 may manage communications with a core network (such as via one or more wired backhaul links). The network communications manager 2210 may manage the transfer of data communications for client devices, such as one or more STAs 104.

In some implementations, the device 2205 may include a single antenna. However, in some other implementations the device 2205 may have more than one antenna, which may be capable of concurrently transmitting or receiving multiple wireless transmissions. The transceiver 2215 may communicate bi-directionally via the one or more antennas 2225 using wired or wireless links as described herein. The transceiver 2215 may represent a wireless transceiver and may communicate bi-directionally with another wireless transceiver. The transceiver 2215 also may include a modem to modulate the packets and provide the modulated packets to one or more antennas 2225 for transmission, and to demodulate packets received from the one or more antennas 2225. The transceiver 2215, or the transceiver 2215 and one or more antennas 2225, may be an example of a transmitter, a receiver, or any combination thereof or component thereof, as described herein.

The memory 2230 may include RAM and ROM. The memory 2230 may store computer-readable, computer-executable, or processor-executable code, such as code 2235. The code 2235 may include instructions that, when executed by the processor 2240, cause the device 2205 to perform various functions described herein. In some implementations, the memory 2230 may include, among other things, a BIOS which may control basic hardware or software operation such as the interaction with peripheral components or devices.

The processor 2240 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 2240 may be configured to operate a memory array using a memory controller. In some other implementations, a memory controller may be integrated into the processor 2240. The processor 2240 may be configured to execute computer-readable instructions stored in a memory (such as the memory 2230) to cause the device 2205 to perform various functions (such as functions or tasks supporting physical protocol data unit for ambient power devices). The device 2205 or a component of the device 2205 may include a processor 2240 and memory 2230 coupled to the processor 2240, the processor 2240 and memory 2230 configured to perform various functions described herein.

The inter-station communications manager 2245 may manage communications with other APs 102, and may include a controller or scheduler for controlling communications with STAs 104 in cooperation with other APs 102. The inter-station communications manager 2245 may coordinate scheduling for transmissions to APs 105 for various interference mitigation techniques such as beamforming or joint transmission. In some implementations, the inter-station communications manager 2245 may provide an X2 interface within an LTE/LTE-A wireless communication network technology to provide communication between APs 105.

The communications manager 2220 may support wireless communications in accordance with examples as disclosed herein. The communications manager 2220 is capable of, configured to, or operable to support a means for transmitting or receiving a PLCP PPDU over an 80 MHz, where the 80 MHz distribution bandwidth is punctured providing a 60 MHz distribution bandwidth.

By including or configuring the communications manager 2220 in accordance with examples as described herein, the device 2205 may support techniques for means for transmitting or receiving a PLCP PPDU over an 80 MHz, where the 80 MHz distribution bandwidth.

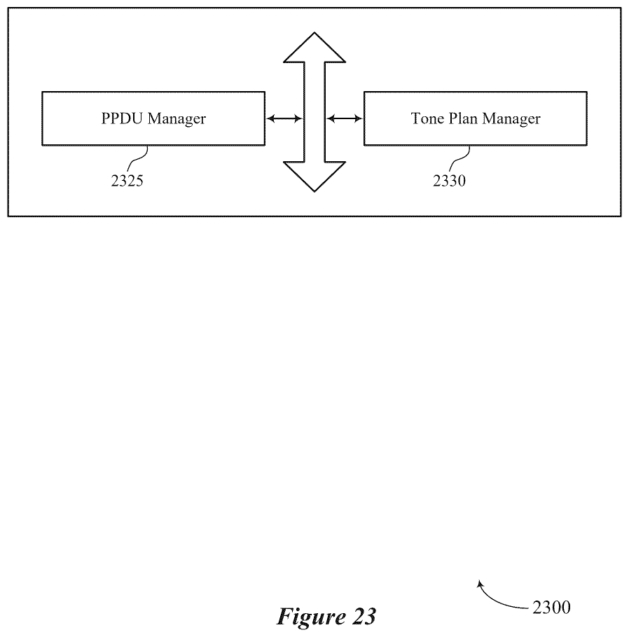

FIG. 23 shows a block diagram of an example wireless communication device 2300 that supports techniques for tone mapping for 60 MHz distribution bandwidth. In some examples, the wireless communication device 2300 is configured to perform the processes 2400, 2500, 2600, 2700, 2800, and 2900 described with reference to FIGS. 23, 24, 25, 26, 27, 28, and 29, respectively. The wireless communication device 2300 may include one or more chips, SoCs, chipsets, packages, components or devices that individually or collectively constitute or include a processing system. The processing system may interface with other components of the wireless communication device 2300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 2300 may transmit the information output from the chip. In such an example, the second interface may refer to an interface between the processing system of the chip and a reception component, such that the wireless communication device 2300 may receive information that is passed to the processing system. In some such examples, the first interface also may obtain information, such as from the transmission component, and the second interface also may output information, such as to the reception component.

The processing system of the wireless communication device 2300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2300 can be configurable or configured for use in an AP or STA, such as the AP 102 or the STA 104 described with reference to FIG. 1. In some other examples, the wireless communication device 2300 can be an AP or STA that includes such a processing system and other components including multiple antennas. The wireless communication device 2300 is capable of transmitting and receiving wireless communications in the form of, for example, wireless packets. For example, the wireless communication device 2300 can be configurable or configured to transmit and receive packets in the form of physical layer PPDUs and MPDUs conforming to one or more of the IEEE 802.11 family of wireless communication protocol standards. In some other examples, the wireless communication device 2300 can be configurable or configured to transmit and receive signals and communications conforming to one or more 3GPP specifications including those for 5G NR or 6G. In some examples, the wireless communication device 2300 also includes or can be coupled with one or more application processors which may be further coupled with one or more other memories. In some examples, the wireless communication device 2300 further includes a user interface (UI) (such as a touchscreen or keypad) and a display, which may be integrated with the UI to form a touchscreen display that is coupled with the processing system. In some examples, the wireless communication device 2300 may further include one or more sensors such as, for example, one or more inertial sensors, accelerometers, temperature sensors, pressure sensors, or altitude sensors, that are coupled with the processing system. In some examples, the wireless communication device 2300 further includes at least one external network interface coupled with the processing system that enables communication with a core network or backhaul network that enables the wireless communication device 2300 to gain access to external networks including the Internet.

The wireless communication device 2300 includes a PPDU manager 2325 and a tone plan manager 2330. Portions of one or more of the PPDU manager 2325 and the tone plan manager 2330 may be implemented at least in part in hardware or firmware. For example, one or more of the PPDU manager 2325 and the tone plan manager 2330 may be implemented at least in part by at least a processor or a modem. In some examples, portions of one or more of the PPDU manager 2325 and the tone plan manager 2330 may be implemented at least in part by a processor and software in the form of processor-executable code stored in memory.

The wireless communication device 2300 may support wireless communications in accordance with examples as disclosed herein. The PPDU manager 2325 is configurable or configured to obtain data for transmission in a PLCP PPDU. The tone plan manager 2330 is configurable or configured to transmit the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth.

In some examples, a first tone of the second 20 MHz dRU tone plan is offset relative to a first tone of the first 20 MHz dRU by two tones.

In some examples, a first tone of the third 20 MHz dRU tone plan is offset relative to a first tone of the first 20 MHz dRU by one tone.

In some examples, a set of twenty-six tone dRU is associated with each of the first 20 MHz dRU tone plan, the second 20 MHz dRU tone plan, and the third 20 MHz dRU tone plan. In some examples, the transmission of the PPDU abstains from using the set of the twenty-six tone dRU.

In some examples, a first set of pilot tones for a first twenty-six tone dRU is associated with the first 20 MHz dRU tone plan, a second set of pilot tones for a second twenty-six tone dRU is associated with the second 20 MHz dRU tone plan, and a third set of pilot tones for a third twenty-six tone dRU is associated with the third 20 MHz dRU tone plan. In some examples, the second set of pilot tones is offset relative to the first set of pilot tones and the third set of pilot tones is offset relative to the first set of pilot tones.

In some examples, the second set of pilot tones is offset relative to the first set of pilot tones by one tone in twenty-six distributed tones for the second twenty-six tone dRU.

In some examples, the first set of pilot tones is offset relative to tone one and the third set of pilot tones is offset relative to tone twenty-six in twenty-six distributed tones for the third twenty-six tone dRU.

In some examples, the first set of pilot tones is offset relative to tone one and the third set of pilot tones is offset with associated indices of the third twenty-six tone reversed.

In some examples, the first set of pilot tones is offset relative to tone one and the third set of pilot tones are offset within indices one, two, three, and four and within indices six, seven, eight, and nine.

In some examples, a sequence of values representing a short training field (STF) of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Additionally, or alternatively, the wireless communication device 2300 may support wireless communications in accordance with examples as disclosed herein. In some examples, the PPDU manager 2325 is configurable or configured to obtain data for transmission in a physical layer convergence protocol (PLCP) protocol data unit (PPDU). In some examples, the tone plan manager 2330 is configurable or configured to transmit the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth.

In some examples, a first set of one or more CSDs is assigned to a first set of one or more dRUs associated with a first 20 MHz of the 60 MHz distribution bandwidth in accordance with the first CSD index pattern. In some examples, a second set of one or more CSDs is assigned to a second set of one or more dRUs associated with a second 20 MHz of the 60 MHz distribution bandwidth in accordance with the second CSD index pattern. In some examples, a third set of one or more CSDs is assigned to a third set of one or more dRUs occupying a third 20 MHz of the 60 MHz distribution bandwidth in accordance with either the first CSD index pattern or the second CSD index pattern.

In some examples, the 60 MHz distribution bandwidth includes three dRUs of 242 tones, the global CSD assignment index values includes a CSD index 2 assigned to a first 242 tone dRU associated with a first 20 MHz of the 60 MHz distribution bandwidth, a global CSD index 5 assigned to a second 242 tone dRU associated with a second 20 MHz of the 60 MHz bandwidth, and a global CSD index 8 assigned to a third 242 tone dRU associated with a third 20 MHz of the 60 MHz distribution bandwidth.

In some examples, the 60 MHz distribution bandwidth includes three dRUs of 106 tones, the global CSD assignment index values includes CSD indices 1, 2 and 3 assigned to a first 106 tone dRU associated with a first 20 MHz of the 60 MHz distribution bandwidth, global CSD indices 4, 5, and 6 assigned to a second 106 tone dRU associated with a second 20 MHz of the 60 MHz bandwidth, and global CSD indices 7 and 8 assigned to a third 106 tone dRU associated with a third 20 MHz of the 60 MHz distribution bandwidth.

In some examples, the 60 MHz distribution bandwidth includes three dRUs of 52 tones, the global CSD assignment index values includes the CSD indices assigned to a first 52 tone dRU associated with a first 20 MHz of the 60 MHz distribution bandwidth based on the global CSD indices associated with the first 106 tone dRU, the CSD indices assigned to a second 52 tone dRU associated with a second 20 MHz of the 60 MHz distribution bandwidth based on the global CSD indices associated with the second 106 tone dRU, the CSD indices assigned to a third 52 tone dRU associated with a third 20 MHz of the 60 MHz distribution bandwidth based on the global CSD indices associated with the third 106 tone dRU.

In some examples, the 60 MHz distribution bandwidth includes three dRUs of 26 tones, the global CSD assignment index values includes the CSD indices assigned to a first 26 tone dRU associated with a first 20 MHz of the 60 MHz distribution bandwidth based on the global CSD indices associated with the first 52 tone dRU, the CSD indices assigned to a second 26 tone dRU associated with a second 20 MHz of the 60 MHz distribution bandwidth based on the global CSD indices associated with the second 52 tone dRU, the CSD indices assigned to a third 26 tone dRU associated with a third 20 MHz of the 60 MHz distribution bandwidth based on the global CSD indices associated with the third 52 tone dRU.

In some examples, a sequence of values representing a short training field (STF) of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Additionally, or alternatively, the wireless communication device 2300 may support wireless communications in accordance with examples as disclosed herein. In some examples, the tone plan manager 2330 is configurable or configured to receive a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth. In some examples, the PPDU manager 2325 is configurable or configured to obtain data from the PPDU.

In some examples, a first tone of the second 20 MHz dRU tone plan is offset relative to a first tone of the first 20 MHz dRU by two tones.

In some examples, a first tone of the third 20 MHz dRU tone plan is offset relative to a first tone of the first 20 MHz dRU by one tone.

In some examples, a set of twenty-six tone dRU is associated with each of the first 20 MHz dRU tone plan, the second 20 MHz dRU tone plan, and the third 20 MHz dRU tone plan. In some examples, a transmission of the PPDU abstains from using the set of the twenty-six tone dRU.

In some examples, a first set of pilot tones for a first twenty-six tone dRU is associated with the first 20 MHz dRU tone plan, a second set of pilot tones for a second twenty-six tone dRU is associated with the second 20 MHz dRU tone plan, and a third set of pilot tones for a third twenty-six tone dRU is associated with the third 20 MHz dRU tone plan. In some examples, the second set of pilot tones is offset relative to the first set of pilot tones and the third set of pilot tones is offset relative to the first set of pilot tones.

In some examples, the second set of pilot tones is offset relative to the first set of pilot tones by one tone in twenty-six distributed tones for the second twenty-six tone dRU.

In some examples, the first set of pilot tones is offset relative to tone one and the third set of pilot tones is offset relative to tone twenty-six in twenty-six distributed tones for the third twenty-six tone dRU.

In some examples, the first set of pilot tones is offset relative to tone one and the third set of pilot tones is offset with associated indices of the third twenty-six tone reversed.

In some examples, the first set of pilot tones is offset relative to tone one and the third set of pilot tones are offset within indices one, two, three, and four and within indices six, seven, eight, and nine.

In some examples, a sequence of values representing a STF of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Additionally, or alternatively, the wireless communication device 2300 may support wireless communications in accordance with examples as disclosed herein. In some examples, the tone plan manager 2330 is configurable or configured to receive a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth. In some examples, the PPDU manager 2325 is configurable or configured to obtain data from the PPDU.

In some examples, a first set of one or more CSDs is assigned to a first set of one or more dRUs associated with a first 20 MHz of the 60 MHz distribution bandwidth in accordance with the first CSD index pattern. In some examples, a second set of one or more CSDs is assigned to a second set of one or more dRUs associated with a second 20 MHz of the 60 MHz distribution bandwidth in accordance with the second CSD index pattern. In some examples, a third set of one or more CSDs is assigned to a third set of one or more dRUs occupying a third 20 MHz of the 60 MHz distribution bandwidth in accordance with either the first CSD index pattern or the second CSD index pattern.

In some examples, the 60 MHz distribution bandwidth includes three dRUs of 242 tones, the global CSD assignment index values includes a CSD index 2 assigned to a first 242 tone dRU associated with a first 20 MHz of the 60 MHz distribution bandwidth, a global CSD index 5 assigned to a second 242 tone dRU associated with a second 20 MHz of the 60 MHz bandwidth, and a global CSD index 8 assigned to a third 242 tone dRU associated with a third 20 MHz of the 60 MHz distribution bandwidth.

In some examples, the 60 MHz distribution bandwidth includes three dRUs of 106 tones, the global CSD assignment index values includes CSD indices 1, 2 and 3 assigned to a first 106 tone dRU associated with a first 20 MHz of the 60 MHz distribution bandwidth, global CSD indices 4, 5, and 6 assigned to a second 106 tone dRU associated with a second 20 MHz of the 60 MHz bandwidth, and global CSD indices 7 and 8 assigned to a third 106 tone dRU associated with a third 20 MHz of the 60 MHz distribution bandwidth.

In some examples, the 60 MHz distribution bandwidth includes three dRUs of 52 tones, the global CSD assignment index values includes the CSD indices assigned to a first 52 tone dRU associated with a first 20 MHz of the 60 MHz distribution bandwidth based on the global CSD indices associated with the first 106 tone dRU, the CSD indices assigned to a second 52 tone dRU associated with a second 20 MHz of the 60 MHz distribution bandwidth based on the global CSD indices associated with the second 106 tone dRU, the CSD indices assigned to a third 52 tone dRU associated with a third 20 MHz of the 60 MHz distribution bandwidth based on the global CSD indices associated with the third 106 tone dRU.

In some examples, the 60 MHz distribution bandwidth includes three dRUs of 26 tones, the global CSD assignment index values includes the CSD indices assigned to a first 26 tone dRU associated with a first 20 MHz of the 60 MHz distribution bandwidth based on the global CSD indices associated with the first 52 tone dRU, the CSD indices assigned to a second 26 tone dRU associated with a second 20 MHz of the 60 MHz distribution bandwidth based on the global CSD indices associated with the second 52 tone dRU, the CSD indices assigned to a third 26 tone dRU associated with a third 20 MHz of the 60 MHz distribution bandwidth based on the global CSD indices associated with the third 52 tone dRU.

In some examples, a sequence of values representing a short training field (STF) of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Additionally, or alternatively, the wireless communication device 2300 may support wireless communications in accordance with examples as disclosed herein. The PPDU manager 2325 is configurable or configured to obtain data for transmission in a physical layer convergence protocol (PLCP) protocol data unit (PPDU). The tone plan manager 2330 is configurable or configured to transmit the PPDU over an 80 megahertz (MHz) distribution bandwidth, where the 80 MHz distribution bandwidth is punctured providing a 60 MHz distribution bandwidth, where one or more cyclic shift delays (CSDs) are respectively applied to a set of multiple distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth.

In some examples, a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

In some examples, the first CSD index pattern includes a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

In some examples, the second CSD index pattern includes a first set of CSD indices associated with a dRU52, a dRU106, and a dRU242 of the first 40 MHz and a second set of CSD indices associated with a dRU106, a dRU242, and a dRU484 of the second 40 MHz.

In some examples, a set CSD indices associated with the dRU106 of a first 40 MHz of the second CSD index pattern are complementary to a set of CSD indices associated with the dRU52 of a third 20 MHz of the second CSD index pattern.

In some examples, a CSD index 8 is assigned to a last dRU242 of the second CSD index pattern.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with the dRU52 of the first 40 MHz of the 80 MHz distribution bandwidth and the second set of CSD indices include a fourth set of CSD indices associated a dRU106 of the second 40 MHz of the 80 MHz distribution bandwidth. In some examples, global CSD indices 1, 2, 3, 4, 5, and 7 are assigned for the dRU106 of the 60 MHz distribution bandwidth. In some examples, global CSD indices 1, 3, and 5 are assigned for a dRU242 of the 60 MHz distribution bandwidth.

In some examples, the second CSD index pattern includes a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

In some examples, a set CSD indices associated with a dRU52 of a first 20 MHz of the second CSD index pattern are complementary to a set CSD indices associated with the dRU106 of a second 40 MHz of the second CSD index pattern.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with a dRU106 of the first 40 MHz of the 80 MHz distribution bandwidth and the second set of CSD indices include a fourth set of CSD indices associated a dRU52 of the second 40 MHz of the 80 MHz distribution bandwidth. In some examples, global CSD indices 2, 4, 5, 6, 7, and 8 are assigned for the dRU106 of the 60 MHz distribution bandwidth. In some examples, global CSD indices 4, 6, and 8 are assigned for a dRU242 of the 60 MHz distribution bandwidth.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with a dRU106 of the first 40 MHz of the 80 MHz distribution bandwidth and the second set of CSD indices include a fourth set of CSD indices associated a dRU52 of the second 40 MHz of the 80 MHz distribution bandwidth. In some examples, global CSD indices 2, 4, 5, 6, 7, and 8 are assigned for the dRU106 of the 60 MHz distribution bandwidth. In some examples, global CSD indices 2, 5, and 7 are assigned for a dRU242 of the 60 MHz distribution bandwidth.

In some examples, the set of multiple global CSD assignment index values associated with the 60 MHz distribution bandwidth includes global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

In some examples, the set of multiple global CSD assignment index values associated with the 60 MHz distribution bandwidth includes global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

In some examples, the set of multiple global CSD assignment index values associated with the 60 MHz distribution bandwidth includes global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

Additionally, or alternatively, the wireless communication device 2300 may support wireless communications in accordance with examples as disclosed herein. In some examples, the tone plan manager 2330 is configurable or configured to receive a physical layer convergence protocol (PLCP) protocol data unit (PPDU) over an 80 megahertz (MHz) distribution bandwidth, where the 80 MHz distribution bandwidth is punctured providing a 60 MHz distribution bandwidth, where one or more cyclic shift delays (CSDs) are respectively applied to a set of multiple distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth. In some examples, the PPDU manager 2325 is configurable or configured to obtain data from the PPDU.

In some examples, a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

In some examples, the first CSD index pattern includes a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

In some examples, the second CSD index pattern includes a first set of CSD indices associated with a dRU52, a dRU106, and a dRU242 of the first 40 MHz and a second set of CSD indices associated with a dRU106, a dRU242, and a dRU484 of the second 40 MHz.

In some examples, a set CSD indices associated with the dRU106 of a first 40 MHz of the second CSD index pattern are complementary to a set of CSD indices associated with the dRU52 of a third 20 MHz of the second CSD index pattern.

In some examples, a CSD index 8 is assigned to a last dRU242 of the second CSD index pattern.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with the dRU52 of the first 40 MHz of the 80 MHz distribution bandwidth and the second set of CSD indices include a fourth set of CSD indices associated a dRU106 of the second 40 MHz of the 80 MHz distribution bandwidth. In some examples, global CSD indices 1, 2, 3, 4, 5, and 7 are assigned for the dRU106 of the 60 MHz distribution bandwidth. In some examples, global CSD indices 1, 3, and 5 are assigned for a dRU242 of the 60 MHz distribution bandwidth.

In some examples, the second CSD index pattern includes a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

In some examples, a set CSD indices associated with a dRU52 of a first 20 MHz of the second CSD index pattern are complementary to a set CSD indices associated with the dRU106 of a second 40 MHz of the second CSD index pattern.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with a dRU106 of the first 40 MHz of the 80 MHz distribution bandwidth and the second set of CSD indices include a fourth set of CSD indices associated a dRU52 of the second 40 MHz of the 80 MHz distribution bandwidth. In some examples, global CSD indices 2, 4, 5, 6, 7, and 8 are assigned for the dRU106 of the 60 MHz distribution bandwidth. In some examples, global CSD indices 4, 6, and 8 are assigned for a dRU242 of the 60 MHz distribution bandwidth.

In some examples, the second CSD index pattern includes a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth. In some examples, the first set of CSD indices include a third set of CSD indices associated with a dRU106 of the first 40 MHz of the 80 MHz distribution bandwidth and the second set of CSD indices include a fourth set of CSD indices associated a dRU52 of the second 40 MHz of the 80 MHz distribution bandwidth. In some examples, global CSD indices 2, 4, 5, 6, 7, and 8 are assigned for the dRU106 of the 60 MHz distribution bandwidth. In some examples, global CSD indices 2, 5, and 7 are assigned for a dRU242 of the 60 MHz distribution bandwidth.

In some examples, the set of multiple global CSD assignment index values associated with the 60 MHz distribution bandwidth includes global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

In some examples, the set of multiple global CSD assignment index values associated with the 60 MHz distribution bandwidth includes global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

In some examples, the set of multiple global CSD assignment index values associated with the 60 MHz distribution bandwidth includes global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

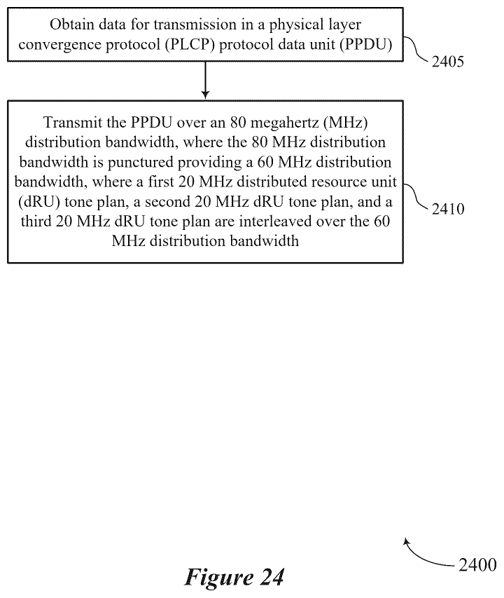

FIG. 24 shows a flowchart illustrating an example process 2400 performable by or at a wireless device that supports techniques for tone mapping for 60 MHz distribution bandwidth. The operations of the process 2400 may be implemented by a wireless device or its components as described herein. For example, the process 2400 may be performed by a wireless communication device, such as the wireless communication device 2300 described with reference to FIG. 23, operating as or within a wireless AP or a wireless STA. In some examples, the process 2400 may be performed by a wireless AP or a wireless STA, such as one of the APs 102 or the STAs 104 described with reference to FIG. 1.

In some examples, in 005, the wireless device may obtain data for transmission in a PLCP PPDU. The operations of 2405 may be performed in accordance with examples as disclosed herein. In some implementations, aspects of the operations of 2405 may be performed by a PPDU manager 2325 as described with reference to FIG. 23.

In some examples, in 2410, the wireless device may transmit the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth. The operations of 2410 may be performed in accordance with examples as disclosed herein. In some implementations, aspects of the operations of 2410 may be performed by a tone plan manager 2330 as described with reference to FIG. 23.

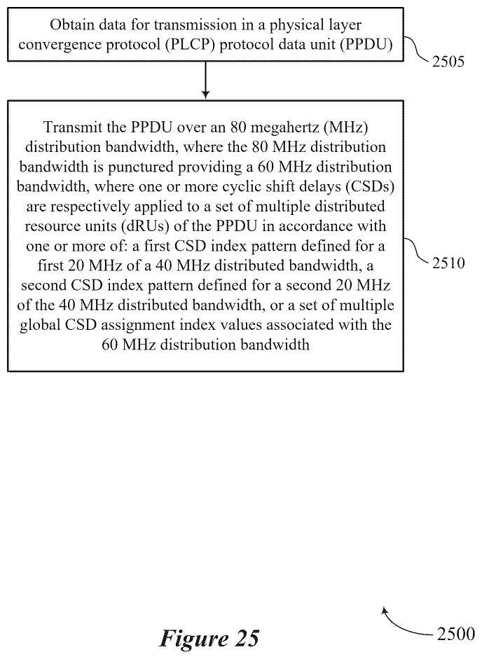

FIG. 25 shows a flowchart illustrating an example process 2500 performable by or at a wireless device that supports techniques for tone mapping for 60 MHz distribution bandwidth. The operations of the process 2500 may be implemented by a wireless device or its components as described herein. For example, the process 2500 may be performed by a wireless communication device, such as the wireless communication device 2300 described with reference to FIG. 23, operating as or within a wireless AP or a wireless STA. In some examples, the process 2500 may be performed by a wireless AP or a wireless STA, such as one of the APs 102 or the STAs 104 described with reference to FIG. 1.

In some examples, in 2505, the wireless device may obtain data for transmission in a PLCP PPDU. The operations of 2505 may be performed in accordance with examples as disclosed herein. In some implementations, aspects of the operations of 2505 may be performed by a PPDU manager 2325 as described with reference to FIG. 23.

In some examples, in 2510, the wireless device may transmit the PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth. The operations of 2510 may be performed in accordance with examples as disclosed herein. In some implementations, aspects of the operations of 2510 may be performed by a tone plan manager 2330 as described with reference to FIG. 23.

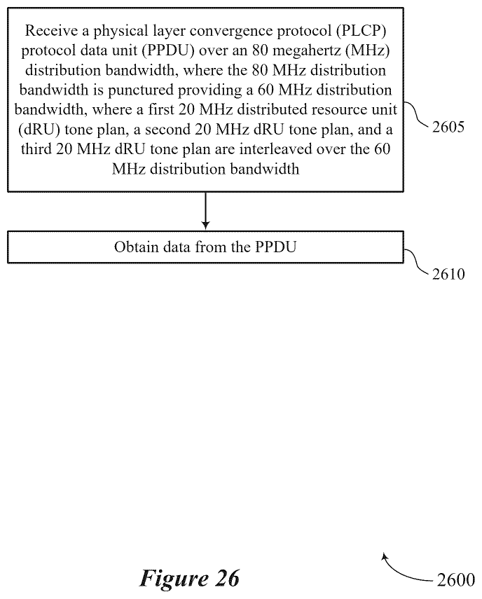

FIG. 26 shows a flowchart illustrating an example process 2600 performable by or at a wireless device that supports techniques for tone mapping for 60 MHz distribution bandwidth. The operations of the process 2600 may be implemented by a wireless device or its components as described herein. For example, the process 2600 may be performed by a wireless communication device, such as the wireless communication device 2300 described with reference to FIG. 23, operating as or within a wireless AP or a wireless STA. In some examples, the process 2600 may be performed by a wireless AP or a wireless STA, such as one of the APs 102 or the STAs 104 described with reference to FIG. 1.

In some examples, in 2605, the wireless device may receive a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth. The operations of 2605 may be performed in accordance with examples as disclosed herein. In some implementations, aspects of the operations of 2605 may be performed by a tone plan manager 2330 as described with reference to FIG. 23.

In some examples, in 2610, the wireless device may obtain data from the PPDU. The operations of 2610 may be performed in accordance with examples as disclosed herein. In some implementations, aspects of the operations of 2610 may be performed by a PPDU manager 2325 as described with reference to FIG. 23.

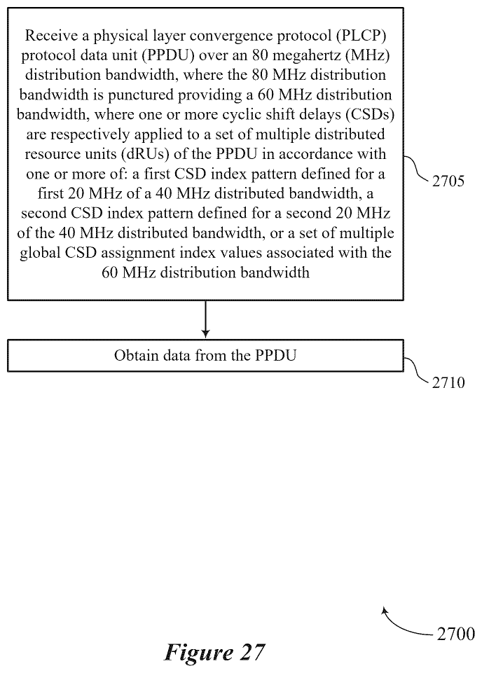

FIG. 27 shows a flowchart illustrating an example process 2700 performable by or at a wireless device that supports techniques for tone mapping for 60 MHz distribution bandwidth. The operations of the process 2700 may be implemented by a wireless device or its components as described herein. For example, the process 2700 may be performed by a wireless communication device, such as the wireless communication device 2300 described with reference to FIG. 23, operating as or within a wireless AP or a wireless STA. In some examples, the process 2700 may be performed by a wireless AP or a wireless STA, such as one of the APs 102 or the STAs 104 described with reference to FIG. 1.

In some examples, in 2705, the wireless device may receive a PLCP PPDU over an 80 MHz distribution bandwidth, where the 80 MHz distribution bandwidth is punctured providing a 60 MHz distribution bandwidth, where one or more CSDs are respectively applied to a set of multiple dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a set of multiple global CSD assignment index values associated with the 60 MHz distribution bandwidth. The operations of 2705 may be performed in accordance with examples as disclosed herein. In some implementations, aspects of the operations of 2705 may be performed by a tone plan manager 2330 as described with reference to FIG. 23.

In some examples, in 2710, the wireless device may obtain data from the PPDU. The operations of 2710 may be performed in accordance with examples as disclosed herein. In some implementations, aspects of the operations of 2710 may be performed by a PPDU manager 2325 as described with reference to FIG. 23.

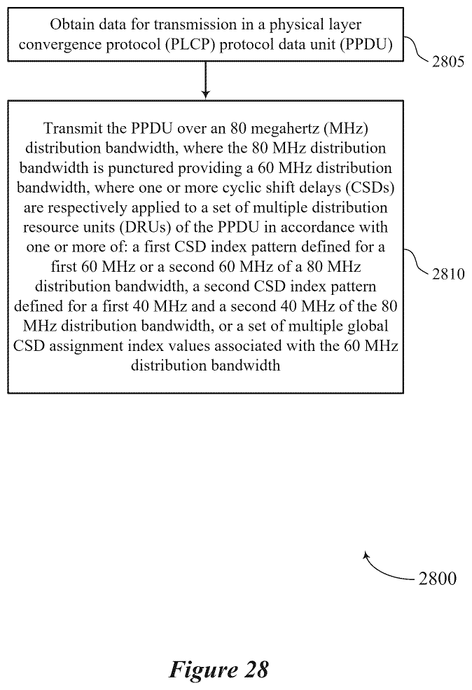

FIG. 28 shows a flowchart illustrating an example process 2800 performable by or at a wireless device that supports techniques for tone mapping for 60 MHz distribution bandwidth. The operations of the process 2800 may be implemented by a wireless device or its components as described herein. For example, the process 2800 may be performed by a wireless communication device, such as the wireless communication device 2300 described with reference to FIG. 23, operating as or within a wireless AP or a wireless STA. In some examples, the process 2800 may be performed by a wireless AP or a wireless STA, such as one of the APs 102 or the STAs 104 described with reference to FIG. 1.

In some examples, in 2805, the wireless device may obtain data for transmission in a physical layer convergence protocol (PLCP) protocol data unit (PPDU). The operations of 2805 may be performed in accordance with examples as disclosed herein. In some implementations, aspects of the operations of 2805 may be performed by a PPDU manager 2325 as described with reference to FIG. 23.

In some examples, in 2810, the wireless device may transmit the PPDU over an 80 megahertz (MHz) distribution bandwidth, where the 80 MHz distribution bandwidth is punctured providing a 60 MHz distribution bandwidth, where one or more cyclic shift delays (CSDs) are respectively applied to a set of multiple distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth. The operations of 2810 may be performed in accordance with examples as disclosed herein. In some implementations, aspects of the operations of 2810 may be performed by a tone plan manager 2330 as described with reference to FIG. 23.

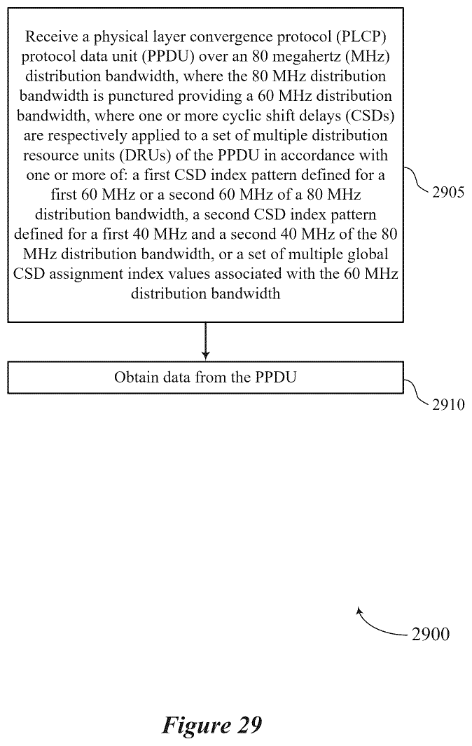

FIG. 29 shows a flowchart illustrating an example process 2900 performable by or at a wireless device that supports techniques for tone mapping for 60 MHz distribution bandwidth. The operations of the process 2900 may be implemented by a wireless device or its components as described herein. For example, the process 2900 may be performed by a wireless communication device, such as the wireless communication device 2300 described with reference to FIG. 23, operating as or within a wireless AP or a wireless STA. In some examples, the process 2900 may be performed by a wireless AP or a wireless STA, such as one of the APs 102 or the STAs 104 described with reference to FIG. 1.

In some examples, in 2905, the wireless device may receive a physical layer convergence protocol (PLCP) protocol data unit (PPDU) over an 80 megahertz (MHz) distribution bandwidth, where the 80 MHz distribution bandwidth is punctured providing a 60 MHz distribution bandwidth, where one or more cyclic shift delays (CSDs) are respectively applied to a set of multiple distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a set of multiple global CSD assignment index values associated with the 60 MHz distribution bandwidth. The operations of 2905 may be performed in accordance with examples as disclosed herein. In some implementations, aspects of the operations of 2905 may be performed by a tone plan manager 2330 as described with reference to FIG. 23.

In some examples, in 2910, the wireless device may obtain data from the PPDU. The operations of 2910 may be performed in accordance with examples as disclosed herein. In some implementations, aspects of the operations of 2910 may be performed by a PPDU manager 2325 as described with reference to FIG. 23.

Implementation examples are described in the following numbered clauses:

The following provides an overview of aspects of the present disclosure:

Aspect 1: A method for wireless communications at a wireless device, comprising: obtaining data for transmission in a PLCP PPDU; and transmitting the PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth.

Aspect 2: The method of aspect 1, where a first tone of the second 20 MHZ dRU tone plan is offset relative to a first tone of the first 20 MHz dRU by two tones.

Aspect 3: The method of any of aspects 1 through 2, where a first tone of the third 20 MHZ dRU tone plan is offset relative to a first tone of the first 20 MHz dRU by one tone.

Aspect 4: The method of aspect 1, where a set of twenty-six tone dRU is associated with each of the first 20 MHz dRU tone plan, the second 20 MHZ dRU tone plan, and the third 20 MHz dRU tone plan, and the transmission of the PPDU abstains from using the set of twenty-six tone dRU.

Aspect 5: The method of aspect 1, where a first set of pilot tones for a first twenty-six tone dRU is associated with the first 20 MHz dRU tone plan, a second set of pilot tones for a second twenty-six tone dRU is associated with the second 20 MHZ dRU tone plan, and a third set of pilot tones for a third twenty-six tone dRU is associated with the third 20 MHz dRU tone plan, and the second set of pilot tones is offset relative to the first set of pilot tones and the third set of pilot tones is offset relative to the first set of pilot tones.

Aspect 6: The method of aspect 5, where the second set of pilot tones is offset relative to the first set of pilot tones by one tone in twenty-six distributed tones for the second twenty-six tone dRU.

Aspect 7: The method of aspect 5, where the first set of pilot tones is offset relative to tone one and the third set of pilot tones is offset relative to tone twenty-six in twenty-six distributed tones for the third twenty-six tone dRU.

Aspect 8: The method of aspect 5, where the first set of pilot tones is offset relative to tone one and the third set of pilot tones is offset with associated indices of the third twenty-six tone reversed.

Aspect 9: The method of aspect 5, where the first set of pilot tones is offset relative to tone one and the third set of pilot tones are offset within indices one, two, three, and four and within indices six, seven, eight, and nine.

Aspect 10: The method of any of aspects 1 through 9, where a sequence of values representing a STF of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Aspect 11: A method for wireless communications at a wireless device, comprising: obtaining data for transmission in a PLCP PPDU; and transmitting the PPDU over an 80 MHz distribution bandwidth, where the 80 MHz distribution bandwidth is punctured providing a 60 MHz distribution bandwidth, where one or more CSDs are respectively applied to a plurality of dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a plurality of global CSD assignment index values associated with the 60 MHz distribution bandwidth.

Aspect 12: The method of aspect 11, where a first set of one or more CSDs is assigned to a first set of one or more dRUs associated with a first 20 MHz of the 60 MHz distribution bandwidth in accordance with the first CSD index pattern, a second set of one or more CSDs is assigned to a second set of one or more dRUs associated with a second 20 MHz of the 60 MHz distribution bandwidth in accordance with the second CSD index pattern, and a third set of one or more CSDs is assigned to a third set of one or more dRUs occupying a third 20 MHz of the 60 MHz distribution bandwidth in accordance with either the first CSD index pattern or the second CSD index pattern.

Aspect 13: The method of aspect 11, where the 60 MHz distribution bandwidth includes three dRUs of 242 tones, the global CSD assignment index values includes a CSD index 2 assigned to a first 242 tone dRU associated with a first 20 MHz of the 60 MHz distribution bandwidth, a global CSD index 5 assigned to a second 242 tone dRU associated with a second 20 MHz of the 60 MHz bandwidth, and a global CSD index 8 assigned to a third 242 tone dRU associated with a third 20 MHz of the 60 MHz distribution bandwidth.

Aspect 14: The method of aspect 11, where the 60 MHz distribution bandwidth includes three dRUs of 106 tones, the global CSD assignment index values includes CSD indices 1, 2 and 3 assigned to a first 106 tone dRU associated with a first 20 MHz of the 60 MHz distribution bandwidth, global CSD indices 4, 5, and 6 assigned to a second 106 tone dRU associated with a second 20 MHz of the 60 MHz bandwidth, and global CSD indices 7 and 8 assigned to a third 106 tone dRU associated with a third 20 MHz of the 60 MHz distribution bandwidth.

Aspect 15: The method of aspect 14, where the 60 MHz distribution bandwidth includes three dRUs of 52 tones, the global CSD assignment index values includes the CSD indices assigned to a first 52 tone dRU associated with a first 20 MHz of the 60 MHz distribution bandwidth based at least in part on the global CSD indices associated with the first 106 tone dRU, the CSD indices assigned to a second 52 tone dRU associated with a second 20 MHz of the 60 MHz distribution bandwidth based at least in part on the global CSD indices associated with the second 106 tone dRU, the CSD indices assigned to a third 52 tone dRU associated with a third 20 MHz of the 60 MHz distribution bandwidth based at least in part on the global CSD indices associated with the third 106 tone dRU.

Aspect 16: The method of aspect 15, where the 60 MHz distribution bandwidth includes three dRUs of 26 tones, the global CSD assignment index values includes the CSD indices assigned to a first 26 tone dRU associated with a first 20 MHz of the 60 MHz distribution bandwidth based at least in part on the global CSD indices associated with the first 52 tone dRU, the CSD indices assigned to a second 26 tone dRU associated with a second 20 MHz of the 60 MHz distribution bandwidth based at least in part on the global CSD indices associated with the second 52 tone dRU, the CSD indices assigned to a third 26 tone dRU associated with a third 20 MHz of the 60 MHz distribution bandwidth based at least in part on the global CSD indices associated with the third 52 tone dRU.

Aspect 17: The method of any of aspects 11 through 16, where a sequence of values representing a STF of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Aspect 18: A method for wireless communications at a wireless device, comprising: receiving a PLCP PPDU over an 80 MHz distribution bandwidth, where the 80 MHz distribution bandwidth is punctured providing a 60 MHz distribution bandwidth, where a first 20 MHz dRU tone plan, a second 20 MHz dRU tone plan, and a third 20 MHz dRU tone plan are interleaved over the 60 MHz distribution bandwidth; and obtaining data from the PPDU.

Aspect 19: The method of aspect 18, where a first tone of the second 20 MHZ dRU tone plan is offset relative to a first tone of the first 20 MHz dRU by two tones.

Aspect 20: The method of any of aspects 18 through 19, where a first tone of the third 20 MHZ dRU tone plan is offset relative to a first tone of the first 20 MHz dRU by one tone.

Aspect 21: The method of aspect 18, where a set of twenty-six tone dRU is associated with each of the first 20 MHz dRU tone plan, the second 20 MHZ dRU tone plan, and the third 20 MHz dRU tone plan, and a transmission of the PPDU abstains from using the set of twenty-six tone dRU.

Aspect 22: The method of aspect 18, where a first set of pilot tones for a first twenty-six tone dRU is associated with the first 20 MHz dRU tone plan, a second set of pilot tones for a second twenty-six tone dRU is associated with the second 20 MHZ dRU tone plan, and a third set of pilot tones for a third twenty-six tone dRU is associated with the third 20 MHz dRU tone plan, and the second set of pilot tones is offset relative to the first set of pilot tones and the third set of pilot tones is offset relative to the first set of pilot tones.

Aspect 23: The method of aspect 22, where the second set of pilot tones is offset relative to the first set of pilot tones by one tone in twenty-six distributed tones for the second twenty-six tone dRU.

Aspect 24: The method of aspect 22, where the first set of pilot tones is offset relative to tone one and the third set of pilot tones is offset relative to tone twenty-six in twenty-six distributed tones for the third twenty-six tone dRU.

Aspect 25: The method of aspect 22, where the first set of pilot tones is offset relative to tone one and the third set of pilot tones is offset with associated indices of the third twenty-six tone reversed.

Aspect 26: The method of aspect 22, where the first set of pilot tones is offset relative to tone one and the third set of pilot tones are offset within indices one, two, three, and four and within indices six, seven, eight, and nine.

Aspect 27: The method of any of aspects 18 through 26, where a sequence of values representing a STF of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Aspect 28: A method for wireless communications at a wireless device, comprising: receiving a PLCP PPDU over an 80 MHz distribution bandwidth, where the 80 MHz distribution bandwidth is punctured providing a 60 MHz distribution bandwidth, where one or more CSDs are respectively applied to a plurality of dRUs of the PPDU in accordance with one or more of: a first CSD index pattern defined for a first 20 MHz of a 40 MHz distributed bandwidth, a second CSD index pattern defined for a second 20 MHz of the 40 MHz distributed bandwidth, or a plurality of global CSD assignment index values associated with the 60 MHz distribution bandwidth; and obtaining data from the PPDU.

Aspect 29: The method of aspect 28, where a first set of one or more CSDs is assigned to a first set of one or more dRUs associated with a first 20 MHz of the 60 MHz distribution bandwidth in accordance with the first CSD index pattern, a second set of one or more CSDs is assigned to a second set of one or more dRUs associated with a second 20 MHz of the 60 MHz distribution bandwidth in accordance with the second CSD index pattern, and a third set of one or more CSDs is assigned to a third set of one or more dRUs occupying a third 20 MHz of the 60 MHz distribution bandwidth in accordance with either the first CSD index pattern or the second CSD index pattern.

Aspect 30: The method of aspect 28, where the 60 MHz distribution bandwidth includes three dRUs of 242 tones, the global CSD assignment index values includes a CSD index 2 assigned to a first 242 tone dRU associated with a first 20 MHz of the 60 MHz distribution bandwidth, a global CSD index 5 assigned to a second 242 tone dRU associated with a second 20 MHz of the 60 MHz bandwidth, and a global CSD index 8 assigned to a third 242 tone dRU associated with a third 20 MHz of the 60 MHz distribution bandwidth.

Aspect 31: The method of aspect 28, where the 60 MHz distribution bandwidth includes three dRUs of 106 tones, the global CSD assignment index values includes CSD indices 1, 2 and 3 assigned to a first 106 tone dRU associated with a first 20 MHz of the 60 MHz distribution bandwidth, global CSD indices 4, 5, and 6 assigned to a second 106 tone dRU associated with a second 20 MHz of the 60 MHz bandwidth, and global CSD indices 7 and 8 assigned to a third 106 tone dRU associated with a third 20 MHz of the 60 MHz distribution bandwidth.

Aspect 32: The method of aspect 31, where the 60 MHz distribution bandwidth includes three dRUs of 52 tones, the global CSD assignment index values includes the CSD indices assigned to a first 52 tone dRU associated with a first 20 MHz of the 60 MHz distribution bandwidth based at least in part on the global CSD indices associated with the first 106 tone dRU, the CSD indices assigned to a second 52 tone dRU associated with a second 20 MHz of the 60 MHz distribution bandwidth based at least in part on the global CSD indices associated with the second 106 tone dRU, the CSD indices assigned to a third 52 tone dRU associated with a third 20 MHz of the 60 MHz distribution bandwidth based at least in part on the global CSD indices associated with the third 106 tone dRU.

Aspect 33: The method of aspect 32, where the 60 MHz distribution bandwidth includes three dRUs of 26 tones, the global CSD assignment index values includes the CSD indices assigned to a first 26 tone dRU associated with a first 20 MHz of the 60 MHz distribution bandwidth based at least in part on the global CSD indices associated with the first 52 tone dRU, the CSD indices assigned to a second 26 tone dRU associated with a second 20 MHz of the 60 MHz distribution bandwidth based at least in part on the global CSD indices associated with the second 52 tone dRU, the CSD indices assigned to a third 26 tone dRU associated with a third 20 MHz of the 60 MHz distribution bandwidth based at least in part on the global CSD indices associated with the third 52 tone dRU.

Aspect 34: The method of any of aspects 28 through 33, where a sequence of values representing a STF of the PPDU are based on a STF sequence associated with triggered transmission and an 80 MHz bandwidth, and the values are populated only over a non-punctured portion of the 80 MHz bandwidth that corresponds to a multiple resource unit four hundred eighty-four plus two hundred forty-two.

Aspect 35: A wireless device for wireless communications, comprising one or more memories storing processor-executable code, and one or more processors coupled with the one or more memories and individually or collectively operable to execute the code to cause the wireless device to perform a method of any of aspects 1 through 10.

Aspect 36: A wireless device for wireless communications, comprising at least one means for performing a method of any of aspects 1 through 10.

Aspect 37: A non-transitory computer-readable medium storing code for wireless communications, the code comprising instructions executable by one or more processors to perform a method of any of aspects 1 through 10.

Aspect 38: A wireless device for wireless communications, comprising one or more memories storing processor-executable code, and one or more processors coupled with the one or more memories and individually or collectively operable to execute the code to cause the wireless device to perform a method of any of aspects 11 through 17.

Aspect 39: A wireless device for wireless communications, comprising at least one means for performing a method of any of aspects 11 through 17.

Aspect 40: A non-transitory computer-readable medium storing code for wireless communications, the code comprising instructions executable by one or more processors to perform a method of any of aspects 11 through 17.

Aspect 41: A wireless device for wireless communications, comprising one or more memories storing processor-executable code, and one or more processors coupled with the one or more memories and individually or collectively operable to execute the code to cause the wireless device to perform a method of any of aspects 18 through 27.

Aspect 42: A wireless device for wireless communications, comprising at least one means for performing a method of any of aspects 18 through 27.

Aspect 43: A non-transitory computer-readable medium storing code for wireless communications, the code comprising instructions executable by one or more processors to perform a method of any of aspects 18 through 27.

Aspect 44: A wireless device for wireless communications, comprising one or more memories storing processor-executable code, and one or more processors coupled with the one or more memories and individually or collectively operable to execute the code to cause the wireless device to perform a method of any of aspects 28 through 34.

Aspect 45: A wireless device for wireless communications, comprising at least one means for performing a method of any of aspects 28 through 34.

Aspect 46: A non-transitory computer-readable medium storing code for wireless communications, the code comprising instructions executable by one or more processors to perform a method of any of aspects 28 through 34.

Aspect 47: A method for wireless communications at a wireless device, comprising: obtaining data for transmission in a PPDU; and transmitting the PPDU over an 80 MHz distribution bandwidth, wherein the 80 MHz distribution bandwidth is punctured providing a 60 MHz distribution bandwidth, wherein one or more CSDs are respectively applied to a plurality of distribution resource units dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth.

Aspect 48: The method of aspect 47, wherein a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

Aspect 49: The method of any of aspects 47-48, wherein the first CSD index pattern comprises a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

Aspect 50: The method of any of aspects 47-49, wherein the second CSD index pattern comprises a first set of CSD indices associated with a dRU52, a dRU106, and a dRU242 of the first 40 MHz and a second set of CSD indices associated with a dRU106, a dRU242, and a dRU484 of the second 40 MHz.

Aspect 51: The method of aspect 50, wherein a set CSD indices associated with the dRU106 of a first 40 MHz of the second CSD index pattern are complementary to a set of CSD indices associated with the dRU52 of a third 20 MHz of the second CSD index pattern.

Aspect 52: The method of aspect 47, wherein a CSD index 8 is assigned to a last dRU242 of the second CSD index pattern.

Aspect 53: The method of aspect 47, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with the dRU52 of the first 40 MHz of the 80 MHz distribution bandwidth and the second set of CSD indices comprise a fourth set of CSD indices associated a dRU106 of the second 40 MHz of the 80 MHz distribution bandwidth, global CSD indices 1, 2, 3, 4, 5, and 7 are assigned for the dRU106 of the 60 MHz distribution bandwidth, and global CSD indices 1, 3, and 5 are assigned for a dRU242 of the 60 MHz distribution bandwidth.

Aspect 54: The method of aspects 47, wherein the second CSD index pattern comprises a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

Aspect 55: The method of aspect 54, wherein a set CSD indices associated with a dRU52 of a first 20 MHz of the second CSD index pattern are complementary to a set CSD indices associated with the dRU106 of a second 40 MHz of the second CSD index pattern.

Aspect 56: The method of aspect 47, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth, global CSD indices 2, 4, 5, 6, 7, and 8 are assigned for the dRU106 of the 60 MHz distribution bandwidth, and global CSD indices 4, 6, and 8 are assigned for a dRU242 of the 60 MHz distribution bandwidth.

Aspect 57: The method of aspect 47, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth, global CSD indices 2, 4, 5, 6, 7, and 8 are assigned for the dRU106 of the 60 MHz distribution bandwidth, and global CSD indices 2, 5, and 7 are assigned for a dRU242 of the 60 MHz distribution bandwidth.

Aspect 58: The method of aspect 47, wherein the plurality of global CSD assignment index values associated with the 60 MHz distribution bandwidth comprises global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

Aspect 59: The method of aspect 47, wherein the plurality of global CSD assignment index values associated with the 60 MHz distribution bandwidth comprises global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

Aspect 60: The method of aspect 47, wherein the plurality of global CSD assignment index values associated with the 60 MHz distribution bandwidth comprises global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

Aspect 61: A method for wireless communications at a wireless device, comprising: receiving a PPDU over an 80 MHz distribution bandwidth, wherein the 80 MHz distribution bandwidth is punctured providing a 60 MHz distribution bandwidth, wherein one or more CSDs are respectively applied to a plurality of dRUs of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth; and obtaining data from the PPDU.

Aspect 62: The method of aspect 61, wherein a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

Aspect 63: The method of any of aspects 61-62, wherein the first CSD index pattern comprises a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

Aspect 64: The method of any of aspects 61-63, wherein the second CSD index pattern comprises a first set of CSD indices associated with a dRU52, a dRU106, and a dRU242 of the first 40 MHz and a second set of CSD indices associated with a dRU106, a dRU242, and a dRU484 of the second 40 MHz.

Aspect 65: The method of aspect 64, wherein a set CSD indices associated with the dRU106 of a first 40 MHz of the second CSD index pattern are complementary to a set of CSD indices associated with the dRU52 of a third 20 MHz of the second CSD index pattern.

Aspect 66: The method of aspect 61, wherein a CSD index 8 is assigned to a last dRU242 of the second CSD index pattern.

Aspect 67: The method of aspect 61, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with the dRU52 of the first 40 MHz of the 80 MHz distribution bandwidth and the second set of CSD indices comprise a fourth set of CSD indices associated a dRU106 of the second 40 MHz of the 80 MHz distribution bandwidth, global CSD indices 1, 2, 3, 4, 5, and 7 are assigned for the dRU106 of the 60 MHz distribution bandwidth, and global CSD indices 1, 3, and 5 are assigned for a dRU242 of the 60 MHz distribution bandwidth.

Aspect 68: The method of aspect 61, wherein the second CSD index pattern comprises a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

Aspect 69: The method of aspect 68, wherein a set CSD indices associated with a dRU52 of a first 20 MHz of the second CSD index pattern are complementary to a set CSD indices associated with the dRU106 of a second 40 MHz of the second CSD index pattern.

Aspect 70: The method of aspect 61, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth, global CSD indices 2, 4, 5, 6, 7, and 8 are assigned for the dRU106 of the 60 MHz distribution bandwidth, and global CSD indices 4, 6, and 8 are assigned for a dRU242 of the 60 MHz distribution bandwidth.

Aspect 71: The method of aspect 61, wherein the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth, the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth, global CSD indices 2, 4, 5, 6, 7, and 8 are assigned for the dRU106 of the 60 MHz distribution bandwidth, and global CSD indices 2, 5, and 7 are assigned for a dRU242 of the 60 MHz distribution bandwidth.

Aspect 72: The method of aspect 61, wherein the plurality of global CSD assignment index values associated with the 60 MHz distribution bandwidth comprises global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

Aspect 73: The method of aspect 61, wherein the plurality of global CSD assignment index values associated with the 60 MHz distribution bandwidth comprises global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

Aspect 74: The method of aspect 61, wherein the plurality of global CSD assignment index values associated with the 60 MHz distribution bandwidth comprises global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

Aspect 75: A wireless device for wireless communications, comprising one or more memories storing processor-executable code, and one or more processors coupled with the one or more memories and individually or collectively operable to execute the code to cause the wireless device to perform a method of any of aspects 47-60.

Aspect 76: A wireless device for wireless communications, comprising at least one means for performing a method of any of aspects 47-60.

Aspect 77: A non-transitory computer-readable medium storing code for wireless communications, the code comprising instructions executable by one or more processors to perform a method of any of aspects 47-60.

Aspect 78: A wireless device for wireless communications, comprising one or more memories storing processor-executable code, and one or more processors coupled with the one or more memories and individually or collectively operable to execute the code to cause the wireless device to perform a method of any of aspects 61-74.

Aspect 79: A wireless device for wireless communications, comprising at least one means for performing a method of any of aspects 61-74.

Aspect 80: A non-transitory computer-readable medium storing code for wireless communications, the code comprising instructions executable by one or more processors to perform a method of any of aspects 61-74. As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
obtain data for transmission in a physical layer convergence protocol (PLCP) protocol data unit (PPDU); and
transmit the PPDU over an 80 megahertz (MHz) distribution bandwidth, wherein the 80 MHz distribution bandwidth is punctured providing a 60 MHz distribution bandwidth, wherein one or more cyclic shift delays (CSDs) are respectively applied to a plurality of distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth.

2. The wireless device of claim 1, wherein a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

3. The wireless device of claim 1, wherein the first CSD index pattern comprises a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

4. The wireless device of claim 1, wherein the second CSD index pattern comprises a first set of CSD indices associated with a dRU52, a dRU106, and a dRU242 of the first 40 MHz and a second set of CSD indices associated with a dRU106, a dRU242, and a dRU484 of the second 40 MHz.

5. The wireless device of claim 4, wherein a set CSD indices associated with the dRU106 of a first 40 MHz of the second CSD index pattern are complementary to a set of CSD indices associated with the dRU52 of a third 20 MHz of the second CSD index pattern.

6. The wireless device of claim 4, wherein a CSD index 8 is assigned to a last dRU242 of the second CSD index pattern.

7. The wireless device of claim 1, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with the dRU52 of the first 40 MHz of the 80 MHz distribution bandwidth and the second set of CSD indices comprise a fourth set of CSD indices associated a dRU106 of the second 40 MHz of the 80 MHz distribution bandwidth,
global CSD indices 1, 2, 3, 4, 5, and 7 are assigned for the dRU106 of the 60 MHz distribution bandwidth, and
global CSD indices 1, 3, and 5 are assigned for a dRU242 of the 60 MHz distribution bandwidth.

8. The wireless device of claim 1, wherein the second CSD index pattern comprises a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

9. The wireless device of claim 8, wherein a set CSD indices associated with a dRU52 of a first 20 MHz of the second CSD index pattern are complementary to a set CSD indices associated with the dRU106 of a second 40 MHz of the second CSD index pattern.

10. The wireless device of claim 1, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth,
global CSD indices 2, 4, 5, 6, 7, and 8 are assigned for the dRU106 of the 60 MHz distribution bandwidth, and
global CSD indices 4, 6, and 8 are assigned for a dRU242 of the 60 MHz distribution bandwidth.

11. The wireless device of claim 1, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth,
global CSD indices 2, 4, 5, 6, 7, and 8 are assigned for the dRU106 of the 60 MHz distribution bandwidth, and
global CSD indices 2, 5, and 7 are assigned for a dRU242 of the 60 MHz distribution bandwidth.

12. The wireless device of claim 1, wherein the plurality of global CSD assignment index values associated with the 60 MHz distribution bandwidth comprises global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

13. The wireless device of claim 1, wherein the plurality of global CSD assignment index values associated with the 60 MHz distribution bandwidth comprises global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

14. The wireless device of claim 1, wherein the plurality of global CSD assignment index values associated with the 60 MHz distribution bandwidth comprises global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

15. A wireless device, comprising:
a processing system that includes processor circuitry and memory circuitry that stores code, the processing system configured to cause the wireless device to:
receive a physical layer convergence protocol (PLCP) protocol data unit (PPDU) over an 80 megahertz (MHz) distribution bandwidth, wherein the 80 MHz distribution bandwidth is punctured providing a 60 MHz distribution bandwidth, wherein one or more cyclic shift delays (CSDs) are respectively applied to a plurality of distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth; and
obtain data from the PPDU.

16. The wireless device of claim 15, wherein a first set of one or more CSDs is assigned to a first set of one or more dRUs associated with the 60 MHz distribution bandwidth in accordance with the first CSD index pattern or a second set of one or more CSDs is assigned to a second set of one or more dRUs associated with the 60 MHz distribution bandwidth in accordance with the second CSD index pattern.

17. The wireless device of claim 15, wherein the first CSD index pattern comprises a first set of CSD indices associated with a dRU52, a dRU106, and a dRU242 of the first 60 MHz of the 80 MHz distribution bandwidth or a second set of CSD indices associated with a dRU52, a dRU106, and a dRU242 of the second 60 MHz of the 80 MHz distribution bandwidth.

18. The wireless device of claim 15, wherein the second CSD index pattern comprises a first set of CSD indices associated with a dRU52, a dRU106, and a dRU242 of the first 40 MHz and a second set of CSD indices associated with a dRU106, a dRU242, and a dRU484 of the second 40 MHz.

19. The wireless device of claim 18, wherein a set CSD indices associated with the dRU106 of a first 40 MHz of the second CSD index pattern are complementary to a set of CSD indices associated with the dRU52 of a third 20 MHz of the second CSD index pattern.

20. The wireless device of claim 18, wherein a CSD index 8 is assigned to a last dRU242 of the second CSD index pattern.

21. The wireless device of claim 15, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with the dRU52 of the first 40 MHz of the 80 MHz distribution bandwidth and the second set of CSD indices comprise a fourth set of CSD indices associated a dRU106 of the second 40 MHz of the 80 MHz distribution bandwidth,
global CSD indices 1, 2, 3, 4, 5, and 7 are assigned for the dRU106 of the 60 MHz distribution bandwidth, and
global CSD indices 1, 3, and 5 are assigned for a dRU242 of the 60 MHz distribution bandwidth.

22. The wireless device of claim 15, wherein the second CSD index pattern comprises a first set of CSD indices associated with a dRU106, a dRU242, and a dRU484 of the first 40 MHz of the 80 MHz distribution bandwidth and a second set of CSD indices associated with a dRU52, a dRU106, and a dRU242 of the second 40 MHz of the 80 MHz distribution bandwidth.

23. The wireless device of claim 22, wherein a set CSD indices associated with a dRU52 of a first 20 MHz of the second CSD index pattern are complementary to a set CSD indices associated with the dRU106 of a second 40 MHz of the second CSD index pattern.

24. The wireless device of claim 15, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth,
global CSD indices 2, 4, 5, 6, 7, and 8 are assigned for the dRU106 of the 60 MHz distribution bandwidth, and
global CSD indices 4, 6, and 8 are assigned for a dRU242 of the 60 MHz distribution bandwidth.

25. The wireless device of claim 15, wherein:
the second CSD index pattern comprises a first set of CSD indices for a dRU52 of the 60 MHz distribution bandwidth based on the first 40 MHz of the 80 MHz distribution bandwidth, and a second set of CSD indices for the dRU52 of the 60 MHz distribution bandwidth based on the second 40 MHz of the 80 MHz distribution bandwidth,
the first set of CSD indices comprise a third set of CSD indices associated with a dRU106 of the first 40 MHz of the 80 MHz distribution bandwidth and the second set of CSD indices comprise a fourth set of CSD indices associated a dRU52 of the second 40 MHz of the 80 MHz distribution bandwidth,
global CSD indices 2, 4, 5, 6, 7, and 8 are assigned for the dRU106 of the 60 MHz distribution bandwidth, and
global CSD indices 2, 5, and 7 are assigned for a dRU242 of the 60 MHz distribution bandwidth.

26. The wireless device of claim 15, wherein the plurality of global CSD assignment index values associated with the 60 MHz distribution bandwidth comprises global CSD indices 1, 5, 3, 7, 4, 8, 2, 6, 3, 7, 4, and 8 assigned for a dRU52 of the 60 MHz distribution bandwidth, global CSD indices 1, 3, 4, 6, 7, and 8 assigned for a dRU106 of the 60 MHz distribution bandwidth, and global CSD indices 1, 4, and 7 assigned for a dRU242 of the 60 MHz distribution bandwidth.

27. The wireless device of claim 15, wherein the plurality of global CSD assignment index values associated with the 60 MHz distribution bandwidth comprises global CSD indices 1, 2, 3, 4, 5, 6, 7, 8, 2, 4, 6, and 8 assigned for a dRU52 of the 60 MHz distribution bandwidth, global CSD indices 1, 3, 5, 7, 2, and 6 assigned for a dRU106 of the 60 MHz distribution bandwidth, and global CSD indices 1, 5, and 2 assigned for a dRU242 of the 60 MHz distribution bandwidth.

28. The wireless device of claim 15, wherein the plurality of global CSD assignment index values associated with the 60 MHz distribution bandwidth comprises global CSD indices 1, 2, 3, 4, 5, 6, 7, 8, 1, 3, 5, and 7 assigned for a dRU52 of the 60 MHz distribution bandwidth, global CSD indices 2, 4, 6, 8, 3, and 7 assigned for a dRU106 of the 60 MHz distribution bandwidth, and global CSD indices 4, 8, and 7 assigned for a dRU242 of the 60 MHz distribution bandwidth.

29. A method for wireless communications at a wireless device, comprising:
obtaining data for transmission in a physical layer convergence protocol (PLCP) protocol data unit (PPDU); and
transmitting the PPDU over an 80 megahertz (MHz) distribution bandwidth, wherein the 80 MHz distribution bandwidth is punctured providing a 60 MHz distribution bandwidth, wherein one or more cyclic shift delays (CSDs) are respectively applied to a plurality of distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth.

30. A method for wireless communications at a wireless device, comprising:
receiving a physical layer convergence protocol (PLCP) protocol data unit (PPDU) over an 80 megahertz (MHz) distribution bandwidth, wherein the 80 MHz distribution bandwidth is punctured providing a 60 MHz distribution bandwidth, wherein one or more cyclic shift delays (CSDs) are respectively applied to a plurality of distribution resource units (dRUs) of the PPDU in accordance with one or more of: a first CSD index pattern defined for a first 60 MHz or a second 60 MHz of a 80 MHz distribution bandwidth, a second CSD index pattern defined for a first 40 MHz and a second 40 MHz of the 80 MHz distribution bandwidth, or a plurality of global CSD assignment index values associated with the 60 MHz distribution bandwidth; and
obtaining data from the PPDU.
